(19) United States
(12) Patent Application Publication
(10) Pub. No.: US 2026/0187155 A1
(43) Pub. Date: Jul. 2, 2026

(54) REFINING OUTPUTS OF GENERATIVE MODELS

(71) Applicant: Google LLC, Mountain View, CA (US)

(72) Inventors: Xiaohang Li, Cupertino, CA (US); Sikun Lin, Mountain View, CA (US); Yang Yang, Campbell, CA (US)

(21) Appl. No.: 18/860,315

(22) PCT Filed: Sep. 29, 2023
(86) PCT No.: PCT/US2023/034167

§ 371 Date: Oct. 25, 2024

(30) Foreign Application Priority Data
Sep. 28, 2023 (WO) PCT/US2023/034006
Sep. 28, 2023 (WO) PCT/US2023/034026

(51) Int. Cl. G06F 16/9035; G06F 16/9032

(52) U.S. Cl. CPC G06F 16/9035; G06F 16/9032

(57) ABSTRACT

One example method includes: obtaining, by an artificial intelligence (AI) system and prior to receiving a query, input data; generating, by the AI system and based on the input data, one or more candidate digital components using a machine learning model; obtaining, by the AI system, user preference data limiting usage of at least one candidate digital component of the one or more candidate digital components; receiving, by the AI system, the query; identifying, by the AI system, one or more digital component regulations associated with the query; identifying, by the AI system based on the one or more digital component regulations and the user preference data, at least one particular candidate digital component of the one or more candidate digital components; and generating, by the AI system and based on the at least one particular candidate digital component, an output digital component.

### BACKGROUND

This specification relates to data processing and refining outputs of generative models.

Advances in machine learning are enabling artificial intelligence to be implemented in more applications. For example, a generative model is a type of machine learning model that aims to learn and mimic the underlying distribution of a given dataset. Unlike discriminative models that focus on classifying data into predefined categories, generative models are designed to generate new data that resembles the original training data. These models are used in various applications, such as image generation, text synthesis, and data augmentation.

### SUMMARY

In general, one innovative aspect of the subject matter described in this specification can be embodied in methods that include the actions of obtaining, by an artificial intelligence (AI) system and prior to receiving a query, input data; generating, by the AI system and based on the input data, one or more candidate digital components using a machine learning model; obtaining, by the AI system, user preference data limiting usage of at least one candidate digital component of the one or more candidate digital components; receiving, by the AI system, the query; identifying, by the AI system, one or more digital component regulations associated with the query; identifying, by the AI system based on the one or more digital component regulations and the user preference data, at least one particular candidate digital component of the one or more candidate digital components; and generating, by the AI system and based on the at least one particular candidate digital component of the one or more candidate digital components, an output digital component.

These and other embodiments can each optionally include one or more of the following features. Generating, by the AI system and based on the input data, the one or more candidate digital components using the machine learning model can include: generating, by the AI system, a prompt comprising the input data; inputting, by the AI system, the prompt into the machine learning model; and generating, by the machine learning model, the one or more candidate digital components.

Generating, by the AI system, the prompt comprising the input data can include: obtaining, by the AI system, additional input data comprising data different from the input data, wherein the additional input data limits digital components generated by the machine learning model; and generating, by the AI system, the prompt comprising the input data and the additional input data.

The user preference data indicates at least one of a serving time period, a geographical location, or an event for using the at least one candidate digital component of the one or more candidate digital components.

The method can include, before receiving the query: obtaining, by the AI system, one or more basic regulation review results associated with the one or more candidate digital components, wherein each basic regulation review result indicates whether a corresponding candidate digital component violates a basic digital component regulation.

Obtaining, by the AI system, the one or more basic regulation review results associated with the one or more candidate digital components can include: inputting a candidate digital component and one or more basic digital component regulations into an additional machine learning model to determine whether the candidate digital component violates at least one of the one or more basic digital component regulations.

The actions can include determining, by the AI system, that a basic regulation review result indicates that a candidate digital component violates a basic digital component regulation; and in response to determining that the basic regulation review result indicates that the candidate digital component violates the basic digital component regulation, removing the candidate digital component from the one or more candidate digital components.

Identifying, by the AI system based on the one or more digital component regulations and the user preference data, the at least one particular candidate digital component of the one or more candidate digital components can include: determining whether a candidate digital component complies with the one or more digital component regulations and the user preference data.

Determining whether the candidate digital component complies with the one or more digital component regulations and the user preference data can include: inputting the candidate digital component, the one or more digital component regulations, and the user preference data into an additional machine learning model to determine whether the candidate digital component complies with the one or more digital component regulations and the user preference data.

The actions can include obtaining, by the AI system, performance data indicating an acceptance level of each candidate digital component of the one or more candidate digital components, wherein identifying, by the AI system based on the one or more digital component regulations and the user preference data, the at least one particular candidate digital component of the one or more candidate digital components can include: identifying, by the AI system based on the one or more digital component regulations, the user preference data, and the performance data, the at least one particular candidate digital component of the one or more candidate digital components.

Another innovative aspect of the subject matter described in this specification can be embodied in methods that include the actions of providing, by an artificial intelligence (AI) system, a plurality of levels of automation comprising an automatic mode; receiving, by the AI system, a first query indicating the automatic mode, the first query comprising a first objective; generating, by the AI system using a generative model and based on the first query, one or more first tasks for achieving the first objective; and automatically executing, by the AI system, the one or more first tasks.

The plurality of levels of automation comprise a semi-automatic mode, and wherein the actions can include: receiving, by the AI system, a second query indicating the semi-automatic mode, the second query comprising a second objective; generating, by the AI system using the generative model and based on the second query, one or more second tasks for achieving the second objective; transmitting, by the AI system to a client device, the one or more second tasks; receiving, by the AI system from the client device, an approval of the one or more second tasks; and executing, by the AI system, the one or more second tasks.

Generating, by the AI system using the generative model and based on the first query, the one or more first tasks for achieving the first objective can include: generating, by the AI system, a prompt comprising the first query; inputting, by the AI system, the prompt into the generative model; and generating, by the generative model, the one or more first tasks.

The actions can include generating, by the AI system, a prioritized task list indicating a sequence of executing the one or more first tasks, wherein automatically executing, by the AI system, the one or more first tasks can include: automatically executing, by the AI system, the one or more first tasks based on the sequence of executing the one or more first tasks.

The actions can include identifying, by the AI system, performance data associated with executing the one or more first tasks; generating, by the AI system, training data based on the performance data; and refining, by the AI system, the generative model using the training data.

The performance data can include at least one of clickthrough rate (CTR), conversion rate (CVR), or cost per day (CPD).

The actions can include generating, by the AI system, a summary based on execution results associated with the one or more first tasks; and transmitting, by the AI system, the summary to a client device.

The techniques described herein can be implemented to achieve the following advantages. In some cases, a generative model can be continuously refined using carefully selected past outputs of the generative model as training data. For example, multiple candidate digital components can be generated and tested based on various criteria, including but not limited to performance data, evaluation results, classification results, safety review results, and user feedback. A candidate digital component which excels in one or more of these criteria can be used to generate training data that can be used to refine the generative model. These feedback loops enable the generative model to generate more digital components similar to the ones that received positive outcomes and to avoid generating digital components similar to the ones that received negative outcomes. This can reduce the rejections of undesirable, low-quality digital components, and thus reduce wasted computing resources that would be used to, for example, generate and evaluate the low-quality digital components and/or regenerate digital components.

In some cases, more than one criterion (including but not limited to performance data, evaluation results, classification results, safety review results, and user feedback) can be combined to identify a candidate component as training data. This can improve overall quality of the digital components generated by the generative model, compared to using a single criterion to select training data. For example, if performance data is the only criterion in identifying the candidate digital component, the generative model can strive to generate additional digital components having good performance (e.g., a high clickthrough rate). This can lead to generating additional digital components including clickbait information. By contrast, the technologies described herein enable to identify the candidate digital component by, for example, ranking the candidate digital components based on combining at least two criteria (may or may not include performance data). This can reduce the generations of undesirable outputs that would otherwise be generated based on one single criterion. The combination of the multiple criteria can be dynamically adjusted based on the optimization objectives of the generative model.

In some cases, the techniques described herein enable to use various heuristics to evaluate different characteristics of each of the candidate digital components, and the scores (e.g., evaluation scores/subscores, user preference levels, and/or user subscores) can be assigned based on the various heuristics. In some implementations, the scores are weighted and aggregated to create a final score, which is used to rank the candidate digital components. Additionally, or alternatively, a machine learning model can be trained to score candidate digital components, and those scores can be used to rank the candidate digital components. One or more of the highest-ranking candidate digital components can then be selected for refining the generative model.

In some cases, the techniques described herein enable to utilize fluid resources—shared resources (e.g., shared GPUs and/or TPUs) accessible by multiple different applications—in an offline mode to improve the cost efficiencies of digital component generations. An online mode typically requires real-time or immediate interaction with users or external systems. Therefore, dedicated resources (e.g., dedicated graphics processing units (GPUs) and/or tensor processing units (TPUs)) are typically deployed in the online mode, where the dedicated resources serve one application. For example, dedicated resources can be deployed to generate digital components and share the generated digital components with the users in real-time. However, dedicated resources are typically expensive. By contrast, the techniques described herein enable generation of digital components offline, where the digital components do not need to be generated or shared with users in real-time. As a result, fluid resources can be utilized to generate and/or serve the digital components. As fluid resources are typically cheaper than dedicated resources, the offline generation of digital components can improve cost efficiencies compared to online generation of digital components.

Additionally, generation of digital components offline can reduce demand for computing, storage, and networking resources used to generate digital components. User query volumes can vary significantly between peak and off-peak periods. In an online process, computing, storage, and networking resources are typically allocated to accommodate a highest expected query load during peak times. However, these resources often remain unused during non-peak hours, resulting in inefficient resource utilization. In contrast, with an offline process, certain user queries can be handled during off-peak periods. Consequently, it becomes feasible to allocate fewer computing, storage, and networking resources than required for peak times (for instance, reserving resources to meet average user demand rather than peak demand), leading to improved resource efficiency.

In some implementations, the techniques described herein enable reviewing and examining a digital component to determine whether the digital component complies with one or more digital component regulations (e.g., government regulations and local policies where an advertisement will be served) and/or user's preference for using the digital component (e.g., user's preference for limiting usage of the digital component to a serving time period, a geographical location, or an event). Therefore, a candidate digital component that violates any digital component regulation and/or user's preference can be identified early and excluded from being processed in subsequent steps. Thereby, the computing, storage, and networking resources associated with processing the digital component can be reduced.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which refining outputs of generative models can be performed, according to an implementation of the present disclosure.

FIG. 2 is a block diagram illustrating interactions between an artificial intelligence system, a generative model, and a client device, according to an implementation of the present disclosure.

FIG. 3 is a flow chart of an example process for refining outputs of generative models based on performance data, according to an implementation of the present disclosure.

FIG. 4 is a flow chart of an example process for refining outputs of generative models based on performance data and evaluation results, according to an implementation of the present disclosure.

FIG. 5 is a flow chart of an example process for refining outputs of generative models based on performance data and classification results, according to an implementation of the present disclosure.

FIG. 6 is a flow chart of an example process for refining outputs of generative models based on performance data and user feedback, according to an implementation of the present disclosure.

FIG. 7 is a flow chart of an example process for generating digital components subject to compliance constraints, according to an implementation of the present disclosure.

FIG. 8 is a block diagram illustrating interactions between an AI system and a client device for using autonomous agents to create and process tasks, according to an implementation of the present disclosure.

FIG. 9 is a block diagram of an example computer system that can be used to perform described operations, according to an implementation of the present disclosure.

Like reference numbers and designations in the various drawings indicate like elements.

### DETAILED DESCRIPTION

This specification describes techniques for refining outputs of generative models and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

Artificial intelligence (AI) is a segment of computer science that focuses on the creation of intelligent agents that can learn and act autonomously (e.g., without human intervention). AI can utilize machine learning, which focuses on developing algorithms that can learn from data; natural language processing, which focuses on understanding and generating human language; and/or computer vision, which is a field that focuses on understanding and interpreting images and videos period.

In existing techniques, it remains difficult to link features or characteristics in a digital component (e.g., an advertisement) with its quality/efficiency. Advanced data analyses may be used to determine patterns in digital component characteristics that might be useful to reproduce in newly created digital components using, for example, complex digital component generation rules. Yet such analyses are specific to a time frame or a location as success can vary with time or the location where they may be served. Such resource heavy analyses need to be carried out at regular intervals and/or various locations, making any digital component generation rules less scalable or adaptable. Indeed, such existing approaches lack a feedback loop that would constantly revisit the digital component generation rules when quality and efficiency change with time and location. There is therefore a disconnect (over time and/or location) between the performance data measuring quality/efficiency of the generated digital component and how the digital component may be generated.

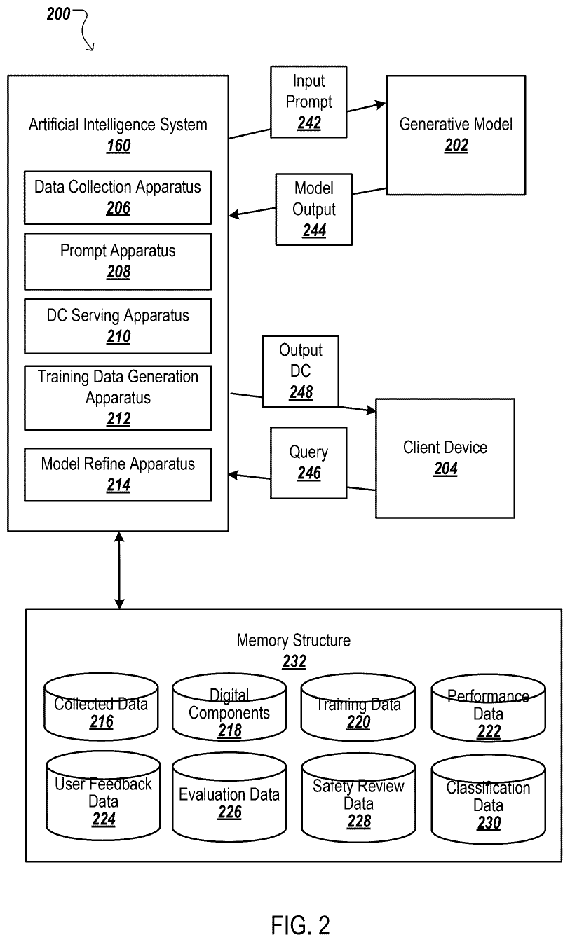

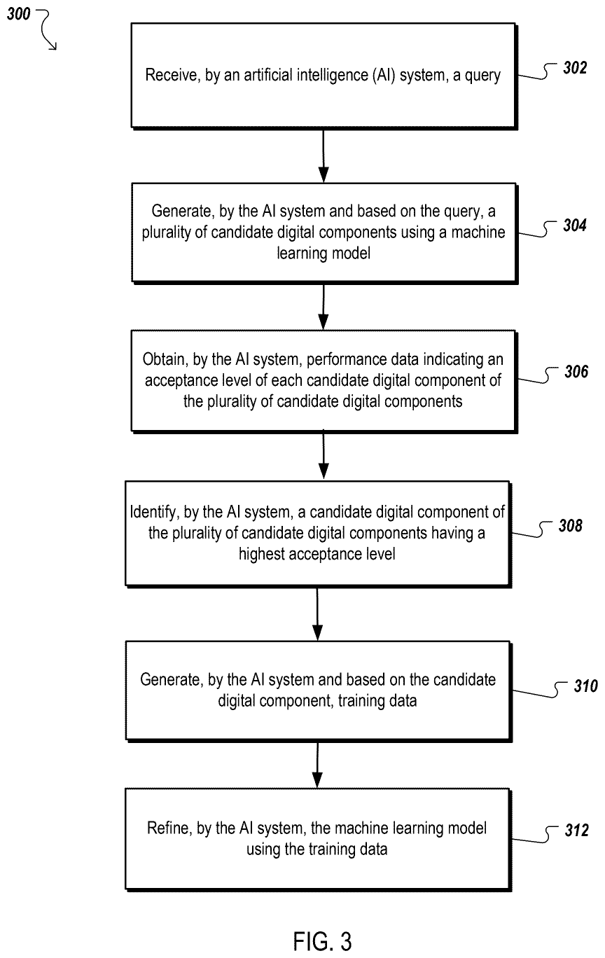

In some implementations, the techniques described throughout this specification enable AI to refine a generative model using performance data (e.g., clickthrough rate (CTR), conversion rate (CVR), and/or cost per day (CPD)) associated with the outputs of the generative model. Such performance data can be seen as a standard or universal measurement of the quality or efficiency of a generated digital component across all available digital components. For example, an AI system can receive a query and/or additional query data, and generate, based on the query and/or the additional query data, a plurality of candidate digital components (e.g., advertisements) using a generative model. The AI system can obtain performance data of the plurality of candidate digital components and identify a candidate digital component of the plurality of candidate digital components having the best performance data. The AI system can generate, based on the candidate digital component, training data, and refine the generative model using the training data. With such a feedback loop, the most efficient generated digital components are selected and fed back into the system by updating the training data of the machine learning model. By constantly training the machine learning model as new digital components are generated, the proposed solution defines an adaptive and scalable generative model that systematically improves itself to replicate characteristics in the highest performing digital components. For instance, the generative model may step away from some features present in generated digital components if newly generated digital component with such equivalent features shows a drop in performance when served. As the proposed system is self-sufficient using the feedback loop, no downtime is required to update the generation rules as in previous systems. Lastly, such a system, as geared towards producing highly performant digital components through the systematic training of its machine learning model, can reach levels of performance in generated contents that would not be otherwise possible with existing solutions. Additional details are described with respect to, for example, FIGS. 2 and 3.

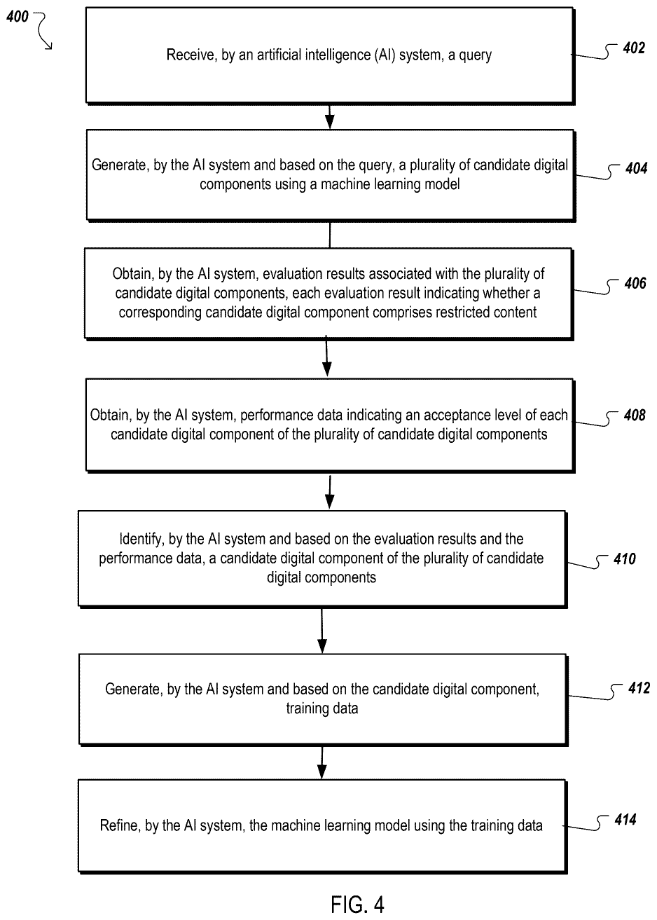

In some implementations, the techniques described throughout this specification enable AI to refine a generative model using evaluations of the outputs of the generative model as well as performance data of the outputs of the generative model. For example, an AI system can receive a query and/or additional query data, and generate, based on the query and/or the additional query data, a plurality of candidate digital components (e.g., advertisements) using a generative model. The AI system can obtain evaluation results associated with the plurality of candidate digital components, each evaluation result indicating whether a corresponding candidate digital component includes restricted content. In addition, the AI system can obtain performance data of the plurality of candidate digital components. The AI system can identify, based on the evaluation results and the performance data, a candidate digital component of the plurality of candidate digital components. The AI system can generate, based on the candidate digital component, training data, and refine the generative model using the training data. Additional details are described with respect to, for example, FIGS. 2 and 4.

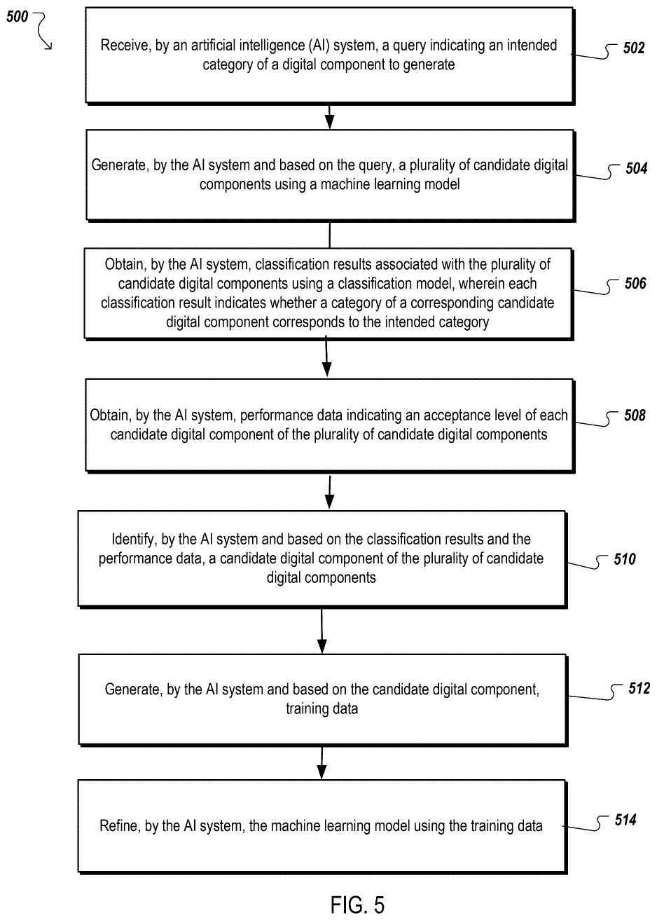

In some implementations, the techniques described throughout this specification enable AI to refine a generative model using classification results and/or safety review results of the outputs of the generative model as well as performance data of the outputs of the generative model. For example, an AI system can receive a query and/or additional query data indicating an intended category of a digital component to generate. The AI system can generate, based on the query and/or the additional query data, a plurality of candidate digital components (e.g., advertisements) using a generative model. The AI system can obtain classification results associated with the plurality of candidate digital components using a classification model, each classification result indicating whether a category of a corresponding candidate digital component corresponds to the intended category. In addition, the AI system can obtain performance data of the plurality of candidate digital components. The AI system can identify, based on the classification results and the performance data, a candidate digital component of the plurality of candidate digital components. The AI system can generate, based on the candidate digital component, training data, and refine the generative model using the training data. Additional details are described with respect to, for example, FIGS. 2 and 5.

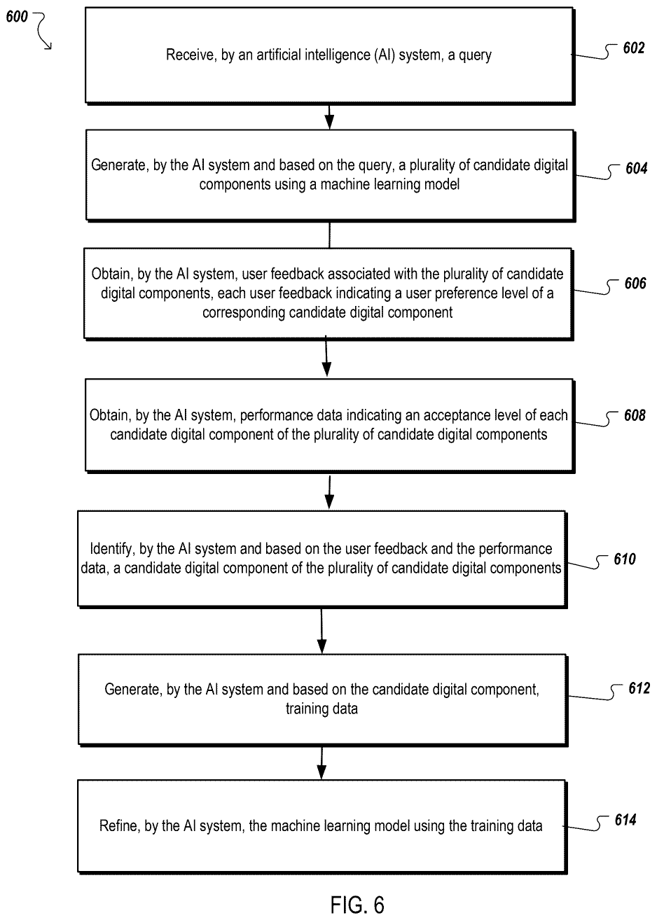

In some implementations, the techniques described throughout this specification enable AI to refine a generative model using user feedback of the outputs of the generative model as well as performance data of the outputs of the generative model. For example, an AI system can receive a query and/or additional query data, and generate, based on the query and/or the additional query data, a plurality of candidate digital components (e.g., advertisements) using a generative model. The AI system can obtain user feedback associated with the plurality of candidate digital components, each user feedback indicating a user preference level of a corresponding candidate digital component. In addition, the AI system can obtain performance data of the plurality of candidate digital components. The AI system can identify, based on the user feedback and the performance data, a candidate digital component of the plurality of candidate digital components. The AI system can generate, based on the candidate digital component, training data, and refine the generative model using the training data. Additional details are described with respect to, for example, FIGS. 2 and 6.

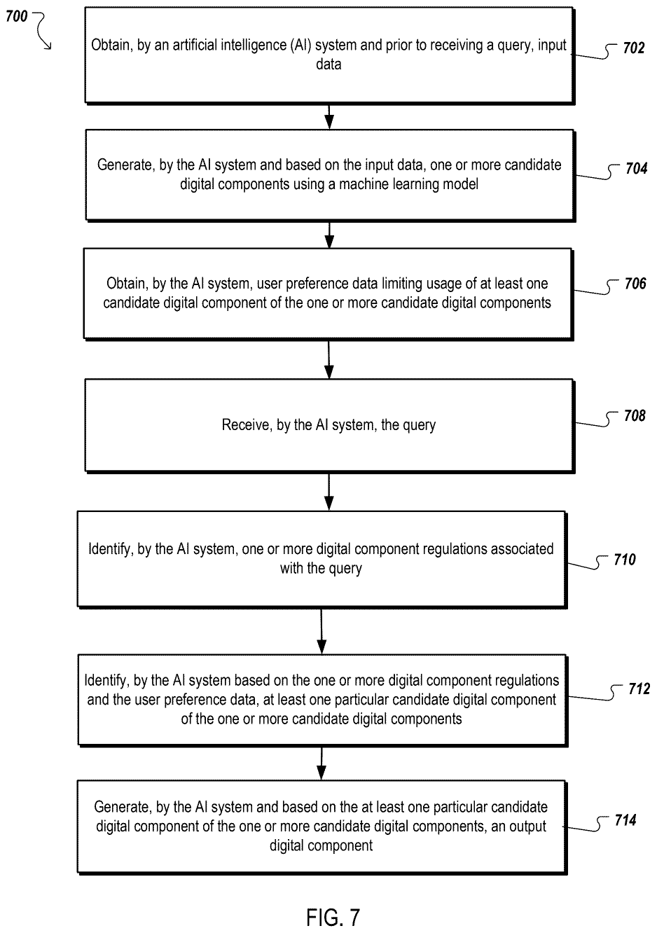

In some implementations, the techniques described throughout this specification enable AI to generate digital components offline subject to compliance constraints. In some cases, input data can be obtained from a user and/or other source(s). Digital components can be generated in the background and provided to the user after a certain period. In some implementations, after generation of an AI-generated digital component, the AI-generated digital component can be reviewed and examined (e.g., using one or more machine learning models) to determine whether it complies with basic digital component regulation(s) (e.g., a candidate digital component shall not include any restricted content). Additionally, in some cases, when an AI-generated digital component is to be served, the AI-generated digital component can be reviewed and examined (e.g., using one or more machine learning models) to determine whether it complies with digital component regulation(s) (e.g., government regulations and local policies where an advertisement will be served) and/or user's preference for using the digital component (e.g., user's preference for limiting usage of the digital component to a serving time period, a geographical location, or an event). Additional details are described with respect to, for example, FIGS. 2 and 7.

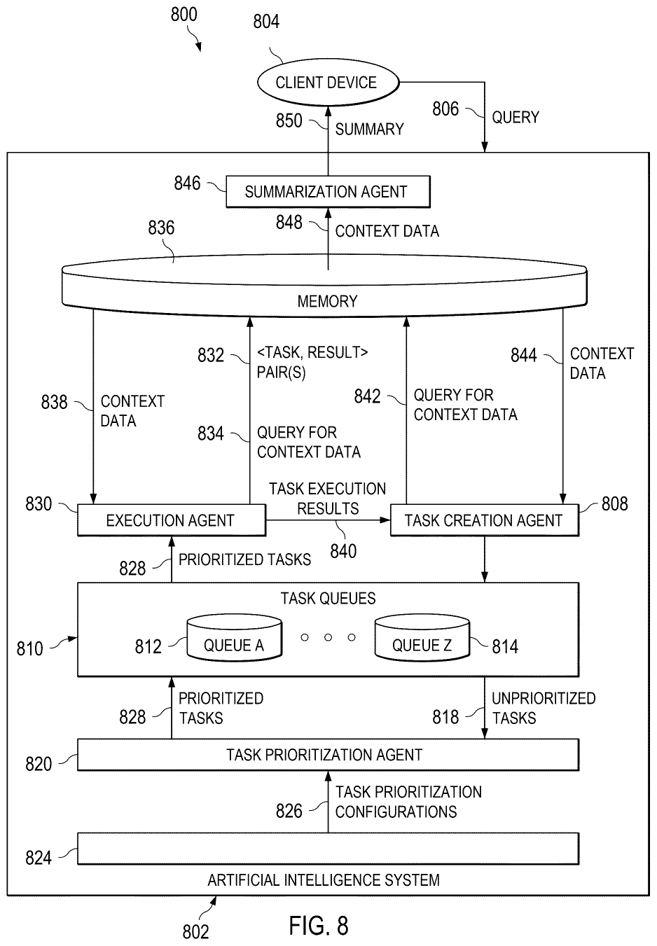

In some implementations, the techniques described throughout this specification enable AI to generate specific tasks based on a general input from a user. The existing technologies focus on assembling different components (e.g., image assets, text assets, and/or video assets) on the fly or creating new AI-generated digital components (e.g., advertisement themes and/or layouts). Particularly, new digital components can be generated based on users'inputs (e.g., product descriptions or images as inputs for generating advertisement text or images). However, this still requires users to provide detailed inputs and keep track of different progress milestones. In some implementations, the techniques described throughout this specification enable AI to generate specific tasks based on a general input (e.g., “increasing the sale of product X by Y % within a budget of Z” or “here are all my products. I want an overall revenue of X”). In some cases, autonomous agents can be created to automate the processes of creating, prioritizing, executing, and reporting the tasks (e.g., asset and format generation, bidding, or strategy adjustment). Additionally, in some implementations, the techniques described throughout this specification enable the AI to provide various levels of automation (e.g., automatic, semi-automatic, or manual) and/or various granularities of tasks to be generated (e.g., coarse or fine) for the user to choose from. Additional details are described with respect to, for example, FIGS. 2 and 8.

In some implementations, the techniques described herein can be used in the context of generating advertisements using generative models. In one example use case, the techniques described herein can be used to refine a generative model specially trained for generating advertisements. For example, in some implementations, an AI system can generate a plurality of candidate advertisements using a generative model and serve the candidate advertisements to audiences. The audiences can interact with the candidate advertisements, such as clicking a hyperlink in an advertisement and/or making a purchase using an advertisement. These interactions can be used to generate performance data (e.g., CTR, CVR, and/or CPD) for the candidate advertisements. The AI system can identify a candidate advertisement having the best performance data (e.g., highest CTR), and generate training data based on the candidate advertisement to refine the generative model. By using performance data as a feedback signal, the generative model can be encouraged to generate additional advertisements similar to the one that received positive performance data. As described in additional detail below, in addition to using performance data as the feedback signal, the AI system can use at least one of evaluation results, classification results, safety review results, or user feedback as feedback signals to refine the generative model. One skilled in the art will appreciate that the techniques described herein are not limited to just these applications but can be applicable in other contexts.

As used throughout this document, the phrase “digital component” refers to a discrete unit of digital content or digital information (e.g., a video clip, audio clip, multimedia clip, gaming content, image, text, bullet point, AI output, language model output, or another unit of content). A digital component can electronically be stored in a physical memory device as a single file or in a collection of files, and digital components can take the form of video files, audio files, multimedia files, image files, or text files and include advertising information, such that an advertisement is a type of digital component.

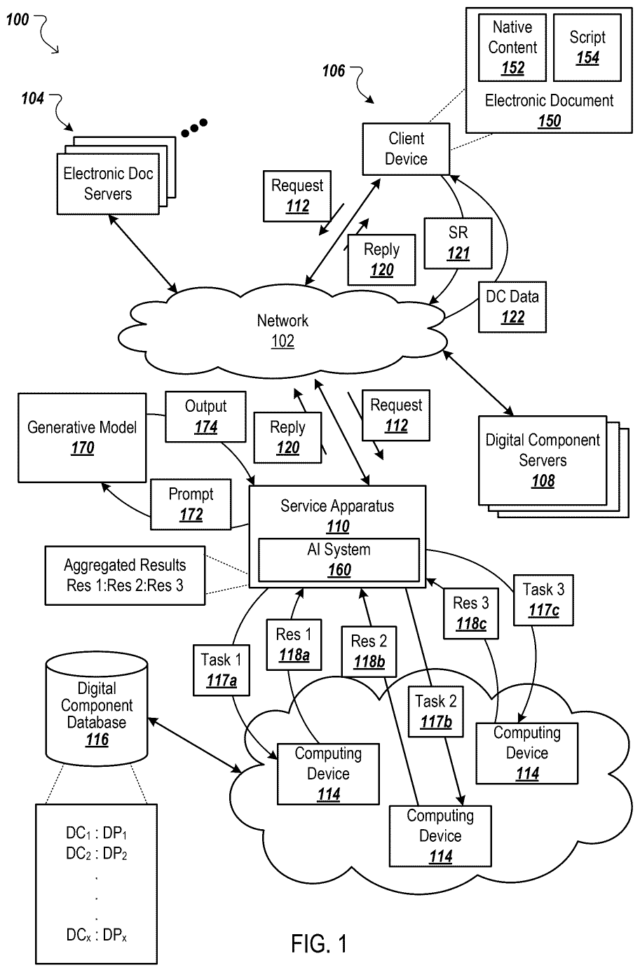

FIG. 1 is a block diagram of an example environment 100 in which refining outputs of generative models can be performed, according to an implementation of the present disclosure. The example environment 100 includes a network 102, such as a local area network (LAN), a wide area network (WAN), the Internet, or a combination thereof. The network 102 connects electronic document servers 104, user devices 106, digital component servers 108, and a service apparatus 110. The example environment 100 may include many different electronic document servers 104, user devices 106, and digital component servers 108.

A client device 106 is an electronic device capable of requesting and receiving online resources over the network 102. Example client devices 106 include personal computers, gaming devices, mobile communication devices, digital assistant devices, augmented reality devices, virtual reality devices, and other devices that can send and receive data over the network 102. A client device 106 typically includes a user application, such as a web browser, to facilitate the sending and receiving of data over the network 102, but native applications (other than browsers) executed by the client device 106 can also facilitate the sending and receiving of data over the network 102.

A gaming device is a device that enables a user to engage in gaming applications, for example, in which the user has control over one or more characters, avatars, or other rendered content presented in the gaming application. A gaming device typically includes a computer processor, a memory device, and a controller interface (either physical or visually rendered) that enables user control over content rendered by the gaming application. The gaming device can store and execute the gaming application locally or execute a gaming application that is at least partly stored and/or served by a cloud server (e.g., online gaming applications). Similarly, the gaming device can interface with a gaming server that executes the gaming application and “streams” the gaming application to the gaming device. The gaming device may be a tablet device, mobile telecommunications device, a computer, or another device that performs other functions beyond executing the gaming application.

Digital assistant devices include devices that include a microphone and a speaker. Digital assistant devices are generally capable of receiving input by way of voice, and respond with content using audible feedback, and can present other audible information. In some situations, digital assistant devices also include a visual display or are in communication with a visual display (e.g., by way of a wireless or wired connection). Feedback or other information can also be provided visually when a visual display is present. In some situations, digital assistant devices can also control other devices, such as lights, locks, cameras, climate control devices, alarm systems, and other devices that are registered with the digital assistant device.

As illustrated, the client device 106 is presenting an electronic document 150. An electronic document is data that presents a set of content at a client device 106. Examples of electronic documents include webpages, word processing documents, portable document format (PDF) documents, images, videos, search results pages, and feed sources. Native applications (e.g., “apps” and/or gaming applications), such as applications installed on mobile, tablet, or desktop computing devices are also examples of electronic documents. Electronic documents can be provided to client devices 106 by electronic document servers 104 (“Electronic Doc Servers”).

For example, the electronic document servers 104 can include servers that host publisher websites. In this example, the client device 106 can initiate a request for a given publisher webpage, and the electronic server 104 that hosts the given publisher webpage can respond to the request by sending machine executable instructions that initiate presentation of the given webpage at the client device 106.

In another example, the electronic document servers 104 can include app servers from which client devices 106 can download apps. In this example, the client device 106 can download files required to install an app at the client device 106, and then execute the downloaded app locally (i.e., on the client device). Alternatively, or additionally, the client device 106 can initiate a request to execute the app, which is transmitted to a cloud server. In response to receiving the request, the cloud server can execute the application and stream a user interface of the application to the client device 106 so that the client device 106 does not have to execute the app itself. Rather, the client device 106 can present the user interface generated by the cloud server's execution of the app and communicate any user interactions with the user interface back to the cloud server for processing.

Electronic documents can include a variety of content. For example, an electronic document 150 can include native content 152 that is within the electronic document 150 itself and/or does not change over time. Electronic documents can also include dynamic content that may change over time or on a per-request basis. For example, a publisher of a given electronic document (e.g., electronic document 150) can maintain a data source that is used to populate portions of the electronic document. In this example, the given electronic document can include a script, such as the script 154, that causes the client device 106 to request content (e.g., a digital component) from the data source when the given electronic document is processed (e.g., rendered or executed) by a client device 106 (or a cloud server). The client device 106 (or cloud server) integrates the content (e.g., digital component) obtained from the data source into the given electronic document to create a composite electronic document including the content obtained from the data source.

In some situations, a given electronic document (e.g., electronic document 150) can include a digital component script (e.g., script 154) that references the service apparatus 110, or a particular service provided by the service apparatus 110. In these situations, the digital component script is executed by the client device 106 when the given electronic document is processed by the client device 106. Execution of the digital component script configures the client device 106 to generate a request for digital components 112 (referred to as a “component request”), which is transmitted over the network 102 to the service apparatus 110. For example, the digital component script can enable the client device 106 to generate a packetized data request including a header and payload data. The component request 112 can include event data specifying features such as a name (or network location) of a server from which the digital component is being requested, a name (or network location) of the requesting device (e.g., the client device 106), and/or information that the service apparatus 110 can use to select one or more digital components, or other content, provided in response to the request. The component request 112 is transmitted, by the client device 106, over the network 102 (e.g., a telecommunications network) to a server of the service apparatus 110.

The component request 112 can include event data specifying other event features, such as the electronic document being requested and characteristics of locations of the electronic document at which digital component can be presented. For example, event data specifying a reference (e.g., a Uniform Resource Locator (URL)) to an electronic document (e.g., webpage) in which the digital component will be presented, available locations of the electronic documents that are available to present digital components, sizes of the available locations, and/or media types that are eligible for presentation in the locations can be provided to the service apparatus 110. Similarly, event data specifying keywords associated with the electronic document (“document keywords”) or entities (e.g., people, places, or things) that are referenced by the electronic document can also be included in the component request 112 (e.g., as payload data) and provided to the service apparatus 110 to facilitate identification of digital components that are eligible for presentation with the electronic document. The event data can also include a search query that was submitted from the client device 106 to obtain a search results page.

Component requests 112 can also include event data related to other information, such as information that a user of the client device has provided, geographic information indicating a state or region from which the component request was submitted, or other information that provides context for the environment in which the digital component will be displayed (e.g., a time of day of the component request, a day of the week of the component request, a type of device at which the digital component will be displayed, such as a mobile device or tablet device). Component requests 112 can be transmitted, for example, over a packetized network, and the component requests 112 themselves can be formatted as packetized data having a header and payload data. The header can specify a destination of the packet and the payload data can include any of the information discussed above.

The service apparatus 110 chooses digital components (e.g., third-party content, such as video files, audio files, images, text, gaming content, augmented reality content, and combinations thereof, which can all take the form of advertising content or non-advertising content) that will be presented with the given electronic document (e.g., at a location specified by the script 154) in response to receiving the component request 112 and/or using information included in the component request 112.

In some implementations, a digital component is selected in less than a second to avoid errors that could be caused by delayed selection of the digital component. For example, delays in providing digital components in response to a component request 112 can result in page load errors at the client device 106 or cause portions of the electronic document to remain unpopulated even after other portions of the electronic document are presented at the client device 106.

Also, as the delay in providing the digital component to the client device 106 increases, it is more likely that the electronic document will no longer be presented at the client device 106 when the digital component is delivered to the client device 106, thereby negatively impacting a user's experience with the electronic document. Further, delays in providing the digital component can result in a failed delivery of the digital component, for example, if the electronic document is no longer presented at the client device 106 when the digital component is provided.

In some implementations, the service apparatus 110 is implemented in a distributed computing system that includes, for example, a server and a set of multiple computing devices 114 that are interconnected and identify and distribute digital component in response to requests 112. The set of multiple computing devices 114 operate together to identify a set of digital components that are eligible to be presented in the electronic document from among a corpus of millions of available digital components (DC₁₋ₓ). The millions of available digital components can be indexed, for example, in a digital component database 116. Each digital component index entry can reference the corresponding digital component and/or include distribution parameters (DP₁-DPₓ) that contribute to (e.g., trigger, condition, or limit) the distribution/transmission of the corresponding digital component. For example, the distribution parameters can contribute to (e.g., trigger) the transmission of a digital component by requiring that a component request include at least one criterion that matches (e.g., either exactly or with some pre-specified level of similarity) one of the distribution parameters of the digital component.

In some implementations, the distribution parameters for a particular digital component can include distribution keywords that must be matched (e.g., by electronic documents, document keywords, or terms specified in the component request 112) in order for the digital component to be eligible for presentation. Additionally, or alternatively, the distribution parameters can include embeddings that can use various different dimensions of data, such as website details and/or consumption details (e.g., page viewport, user scrolling speed, or other information about the consumption of data). The distribution parameters can also require that the component request 112 include information specifying a particular geographic region (e.g., country or state) and/or information specifying that the component request 112 originated at a particular type of client device (e.g., mobile device or tablet device) in order for the digital component to be eligible for presentation. The distribution parameters can also specify an eligibility value (e.g., ranking score, or some other specified value) that is used for evaluating the eligibility of the digital component for distribution/transmission (e.g., among other available digital components).

The identification of the eligible digital component can be segmented into multiple tasks 117a-117c that are then assigned among computing devices within the set of multiple computing devices 114. For example, different computing devices in the set 114 can each analyze a different portion of the digital component database 116 to identify various digital components having distribution parameters that match information included in the component request 112. In some implementations, each given computing device in the set 114 can analyze a different data dimension (or set of dimensions) and pass (e.g., transmit) results (Res 1-Res 3) 118a-118c of the analysis back to the service apparatus 110. For example, the results 118a-118c provided by each of the computing devices in the set 114 may identify a subset of digital components that are eligible for distribution in response to the component request and/or a subset of the digital component that have certain distribution parameters. The identification of the subset of digital components can include, for example, comparing the event data to the distribution parameters, and identifying the subset of digital components having distribution parameters that match at least some features of the event data.

The service apparatus 110 aggregates the results 118a-118c received from the set of multiple computing devices 114 and uses information associated with the aggregated results to select one or more digital components that will be provided in response to the request 112. For example, the service apparatus 110 can select a set of winning digital components (one or more digital components) based on the outcome of one or more content evaluation processes, as discussed below. In turn, the service apparatus 110 can generate and transmit, over the network 102, reply data 120 (e.g., digital data representing a reply) that enable the client device 106 to integrate the set of winning digital components into the given electronic document, such that the set of winning digital components (e.g., winning third-party content) and the content of the electronic document are presented together at a display of the client device 106.

In some implementations, the client device 106 executes instructions included in the reply data 120, which configures and enables the client device 106 to obtain the set of winning digital components from one or more digital component servers 108. For example, the instructions in the reply data 120 can include a network location (e.g., a URL) and a script that causes the client device 106 to transmit a server request (SR) 121 to the digital component server 108 to obtain a given winning digital component from the digital component server 108. In response to the request, the digital component server 108 will identify the given winning digital component specified in the server request 121 (e.g., within a database storing multiple digital components) and transmit, to the client device 106, digital component data (DC Data) 122 that presents the given winning digital component in the electronic document at the client device 106.

When the client device 106 receives the digital component data 122, the client device will render the digital component (e.g., third-party content), and present the digital component at a location specified by, or assigned to, the script 154. For example, the script 154 can create a walled garden environment, such as a frame, that is presented within, e.g., beside, the native content 152 of the electronic document 150. In some implementations, the digital component is overlaid over (or adjacent to) a portion of the native content 152 of the electronic document 150, and the service apparatus 110 can specify the presentation location within the electronic document 150 in the reply 120. For example, when the native content 152 includes video content, the service apparatus 110 can specify a location or object within the scene depicted in the video content over which the digital component is to be presented.

The service apparatus 110 can also include an AI system 160 configured to autonomously generate digital components, either prior to a request 112 (e.g., offline) and/or in response to a request 112 (e.g., online or real-time). As described in more detail throughout this specification, the AI system 160 can collect online content about a specific entity (e.g., digital component provider or another entity) and generate digital components based on the collected online content using one or more generative models 170.

Generative models are designed to generate new data that resembles a given training dataset. These models operate by learning the underlying patterns, structures, and relationships present in the training data, enabling them to create new samples that share similar characteristics. The primary goal of generative models is to capture the inherent complexity of the data distribution, allowing them to produce outputs that exhibit the same diversity and variability found in the original dataset.

One of the fundamental concepts in generative models is the generation of data from random noise or latent variables. These models create a mapping between the latent space and the data space, allowing them to generate entirely novel instances that possess meaningful features. Generative models can be broadly categorized into two main types: likelihood-based and adversarial-based.

Likelihood-based generative models, such as Variational Autoencoders (VAEs) and Autoregressive Models, focus on learning the probability distribution of the data. VAEs, for instance, employ an encoder-decoder architecture to map data points into a latent space and then decode them back into the data space. This process encourages the model to learn a more structured and continuous representation of the data distribution.

Adversarial-based generative models, most notably Generative Adversarial Networks (GANs), leverage a different approach. GANs consist of two neural networks: a generator and a discriminator. The generator aims to produce data that is indistinguishable from real data, while the discriminator tries to distinguish between real and generated data. This adversarial process results in the generator improving over time and producing increasingly convincing outputs.

FIG. 2 is a block diagram 200 illustrating interactions between an AI system, a generative model, and a client device, according to an implementation of the present disclosure. In some situations, generative model 202 and client device 204 can, respectively, be the same or similar to the generative model 170 and client device 106 of FIG. 1. The generative model 202 can be, for example, a text-to-text generative model, a text-to-image generative model, a text-to-video generative model, an image-to-image generative model, or any other type of generative model. Although a single generative model 202 is depicted in FIG. 2, the generative model 202 can be a set of different generative models that can be invoked for different tasks for which the different generative models are specially trained. For example, one generative model within the set of generative models may be specially trained to perform content summary tasks, while another model may be specially trained to generate digital components, for example, using the output of the specially trained generative model. Furthermore, the set of models can include a generalized generative model that is larger is size, and capable of generating large amounts of diverse datasets, but this generalized model may have higher latency than the specialized models, which can make it less desirable for use in real-time operations, depending on time latency constraints required to generate content.

The AI system 160 includes a data collection apparatus 206, a prompt apparatus 208, a DC (digital component) serving apparatus 210, a training data generation apparatus 212, and a model refine apparatus 214. The following description refers to these different apparatuses as being implemented independently and each configured to perform a set of operations, but any of these apparatuses could be combined to perform the operations discussed below.

The AI system 160 is in communication with a memory structure 232. The memory structure 232, can include one or more databases. As shown, the memory structure 232 includes a collected data database 216, a digital components database 218, a training data database 220, a performance data database 222, a user feedback data database 224, an evaluation data database 226, a safety review data database 228, and a classification data database 230. Each of these databases 216, 218, 220, 222, 224, 226, 228, and 230 can be implemented in a same hardware memory device, separate hardware memory devices, and/or implemented in a distributed cloud computing environment.

At a high level, the client device 204 transmits a query 246 to the AI system 160. In some examples, a user can submit the query using a frontend interface of the AI system 160 (e.g., a website, or an application of a computing device). In some cases, the query 246 can be, for example, a request for the AI system 160 to generate a digital component (e.g., an advertisement). For example, a user can input a prompt to request the AI system 160 to generate an advertisement.

In some cases, the user can upload, to the AI system 160, one or more original digital components (e.g., images, text, and videos) associated with the query (whether as a part of the query or not), and the original digital component(s) can be used to create the digital components. For example, the original digital component(s) can be image(s) of a product, and the image(s) of the product can be included in one or more advertisements generated by the AI system 160.

In some embodiments, the user can submit additional query data to the AI system 160, where the additional query data can include data not in the query and can limit digital components generated by the AI system 160. For example, the additional query data can include but not limited to, the geographic location(s) targeted by the advertisement, a language of the advertisement, and/or a vertical industry targeted by the advertisement. For example, an advertiser can indicate that the advertisement is aimed at North American markets, should be in English language, and/or is aimed at fashion clothing vertical industry. In some examples, the user provides the additional query data in the same prompt that requests to generate the digital component. In other examples, the additional query data is input separately from the prompt. For example, the AI system 160 can generate one or more follow-up questions in response to the user's prompt, where the one or more follow-up questions are used to solicit input of the additional query data from the user. For example, the follow-up question(s) can be “which geographic location(s) is targeted by the advertisement,” “which language should the advertisement be in,” and/or “which vertical industr(y/ies) is targeted by the advertisement?”

In some examples, the AI system 160 can collect, using the data collection apparatus 206, additional query data not input directly by the user. The data collection apparatus 206 is implemented using at least one computing device (e.g., one or more processors), and can include one or more machine learning models. In some cases, the data collection apparatus 206 can obtain an identity of an entity associated with the query. The identity can include at least one identifier, such as a company or corporation name, a URL, a telephone number, employer ID number, or other means of identifying an entity. The data collection apparatus 206 can obtain the at least one identifier using, for example, an account of the user who submitted the query or from a partner system. The data collection apparatus 206 can automatically identify, based on the identity of the entity, a data source including information about the entity. These data sources can be, but are not limited to, web pages (e.g., the entity's landing page), review compilation pages (e.g., google.com, yelp.com, and crunchbase.com), federal and/or state registries (e.g., the Delaware entity search tool), private databases, news articles, or other suitable sources. In some implementations, a data crawler application automatically queries a plurality of databases, performs searches, and extracts information from the results in response to the process being triggered. The information obtained from these data sources can be bulk text data, a combination of text and images, metadata, or other suitable data and/or media.

In some examples, the data collection apparatus 206 can perform a semantic analysis of the collected information for at least one data source. In some implementations, a single data source is analyzed using semantic analysis. In some implementations, all collected information is analyzed. The semantic analysis can be performed by one or more machine learning algorithms with the overall objective of generating one or more entity attributes associated with the entity. In some cases, the data collection apparatus 206 can perform the semantic analysis by an array of neural networks that operate in series or can include machine learning algorithms that operate in parallel, or otherwise independently of each other. In some implementations, traditional data analysis can be performed in addition to, or separately from, the machine learning processes. Similar to the additional query data, the one or more entity attributes can include, for example, the geographic location(s) targeted by the advertisement, a preferred language of the advertisement, and/or a vertical industry targeted by the advertisement. In some examples, the data collection apparatus 206 can include the one or more entity attributes in the additional query data.

The data collection apparatus 206 can store the collected data in the collected data database 216. For example, the data collection apparatus 206 can index the collected data to the query used to collect the data and/or an entity characterized by the collected data so that the collected data can be retrieved from the collected data database 216 for additional operations performed by the data collection apparatus 206 and/or any operations performed by the AI system 160.

The AI system 160 can generate, using the prompt apparatus 208, an input prompt 242 using the query 246 and/or additional query data. The prompt apparatus 208 can be implemented using at least one computing device (e.g., a device including one or more processors), and can include one or more language models. In some cases, the input prompt 242 can include the query 246 and a set of constraints generated based on, for example, the additional query data. For example, the prompt apparatus 208 can insert, into the input prompt 242, one or more of the entity attribute(s) corresponding to the entity as identified by the data collection apparatus 206. In some implementations, the one or more of the entity attribute(s) inserted into the prompt operates as a contextual constraint that limits content created by the generative model 202 responsive to the input prompt 242. For example, the entity attribute(s) can limit the content created by the generative model to subject matter specified by the entity attribute(s) that is included in the prompt as a contextual constraint.

The AI system 160 can transmit the input prompt 242 to the generative model 202. The generative model 202 can then generate, based on the input prompt 242, a plurality of candidate digital components, and transmit the candidate digital components to the AI system 160 as model output 244. In some cases, the AI system 160 can receive a plurality of original digital components (e.g., original images) associated with the query. The generative model 202 can generate a plurality of candidate digital components (e.g., candidate advertisements) using the original digital components, where each of the plurality of candidate digital components includes at least one of the plurality of original digital components.

The AI system 160 can store the generated candidate digital components in the digital components database 218. For example, the AI system 160 can index the generated candidate digital components to the query used to generate the candidate digital components and/or an entity associated with the candidate digital components, so that the candidate digital components can be retrieved from the digital components database 218 for additional operations performed by the AI system 160.

For example, assume that the query 246 is “Generate an advertisement for sunglasses” and the user uploaded an image of the sunglasses. Also assume that the additional query data indicates that the entity is targeting the fashion clothing vertical market in Japan. The input prompt 242 can take the following form:

Generate a good_output—an advertisement where the query is “Generate an advertisement for sunglasses.” good_output should target the fashion clothing vertical market in Japan.

The generative model 202 can generate multiple candidate advertisements including the image of the sunglasses and having different backgrounds. For example, an advertisement can include Fuji Mountain scene in the background, an advertisement can include snow scene in the background, an advertisement can include backyard scene in the background, and an advertisement can include Eiffel Tower scene in the background.

The AI system 160 can serve, using the DC serving apparatus 210, one or more of the candidate digital components. The DC serving apparatus 210 can be implemented using at least one computing device (e.g., a device including one or more processors), and can include one or more machine learning models. Assuming that the digital component is an advertisement, in some case, the DC serving apparatus 210 can perform advertisement rendering, including rendering and formatting the advertisement to match the publisher's website or app layout. The DC serving apparatus 210 can generate the necessary HyperText Markup Language (HTML), images, or video components to display the advertisement. In some examples, the DC serving apparatus 210 can perform advertisement delivery—the rendered advertisement is transmitted to the publisher's website or app, where it is displayed to the user in the designated advertisement space. In some examples, the DC serving apparatus 210 can serve a plurality of candidate digital components generated in response to the query 246 and collect performance data of the candidate digital components. In some embodiments, the performance data can indicate acceptance levels of the candidate digital components and can be used to evaluate and rank the candidate digital components. The performance data can be based on, for example, user interactions with the candidate digital components. For example, users may interact with the advertisement by clicking on it, watching a video, purchasing a product promoted by the advertisement, or taking other actions. Examples of performance data include but not limited to, CTR, CVR, CPD, and other user actions.

In some cases, the DC serving apparatus 210 can store the performance data in the performance data database 222. For example, the performance data database 222 can index the performance data to the query for which the performance data is generated and/or an entity associated with the performance data, so that the performance data can be retrieved from the performance data database 222 for additional operations performed by the DC serving apparatus 210 and/or the AI system 160.

In some implementations, the DC serving apparatus 210 can operate at the exploration mode or the exploitation mode. The exploration mode can be operated, for example, when the performance data needs to be collected for evaluations of the candidate digital components. When the DC serving apparatus 210 operates at the exploration mode, the DC serving apparatus 210 can randomly select, in each serving of a candidate digital component (e.g., in each delivery of an advertisement), one of the candidate digital components to deliver to users. After a number of servings, each candidate digital component can have a chance to be delivered to the users (e.g., audiences of advertisements), and the performance data of each candidate digital component has a chance to be monitored and recorded. On the other hand, the exploitation mode can be operated, for example, when the generative model has been trained to a certain extent. When the DC serving apparatus 210 operates at the exploitation mode, the DC serving apparatus 210 does not test a plurality of candidate digital components in response to a query. Instead, a digital component generated by the DC serving apparatus 210 can be directly delivered to users and/or the querier who requested to generate the digital component.

In some cases, by serving the candidate digital components, the AI system 160 can determine an acceptance level for each of the candidate digital components and identify a candidate digital component having the highest acceptance level (e.g., highest CTR, highest CVR, and/or highest CPD) among the candidate digital components. In some embodiments, the AI system 160 can perform identification of the candidate digital component upon the occurrence of one or more predetermined conditions, such as a predetermined period has elapsed after delivering the digital component, a candidate digital component's acceptance level has satisfied (e.g., met or exceeded) a predetermined threshold, or other suitable conditions.

The AI system 160 can determine the acceptance level in various ways. In some cases, the acceptance level is determined based on one metric of the performance data. For example, the candidate digital component having the highest CTR, highest CVR, or highest CPD has the highest acceptance level. In some cases, the performance data includes at least two different metrics, and the acceptance level is determined based on a combination of the at least two different metrics. In one example, the acceptance level can be determined based on a weighted sum of the at least two different metrics. In another example, the at least two different metrics can be ranked from the most important metric to the least important metric. First, the candidate digital components can be ranked based on the most important metric from highest to lowest. The candidate digital component ranked the highest using this metric has the highest acceptance level. For candidate digital components that are equal for one metric, the candidate digital components can be ranked based on a lower-ranking metric (i.e., a tiebreaker) to determine their ranking.

In some examples, the AI system 160 can identify the candidate digital component based on one or more other metrics, whether taking performance data into account or not. In some cases, a candidate digital component having the best performance data is not necessarily a desirable output. An example is a clickbait advertisement, which is an online advertisement that is designed to entice viewers to click on it. Clickbait advertisements often use intriguing or sensationalist headlines, images, or phrases to attract users'attention and encourage them to click on the advertisements to learn more. Therefore, a clickbait advertisement may excel in one metric of performance data such as CTR. If CTR is the only metric used to determine the acceptance level, a clickbait advertisement can have the highest acceptance level. However, clickbait advertisement may not be a desirable output because, for example, it can perform poorly on another metric such as CVR.

To prevent such outcome, other metric(s) can be implemented in identifying the candidate digital component. For example, candidate digital components can be ranked based on their performance data from the best to the worst. Starting from the beginning of the ranked candidate digital components, each candidate digital component can be evaluated to determine whether its attribute(s) satisfies predetermined condition(s) (e.g., the candidate digital component does not include any clickbait advertising information). The first candidate digital component whose attribute(s) satisfies the predetermined condition(s) can be identified as the candidate digital component. In some cases, the candidate digital component can be identified based on at least one of the following: performance data associated with the plurality of candidate digital components (e.g., using similar operations described above with respect to identifying the candidate digital component based on acceptance levels), evaluation results associated with the plurality of candidate digital components (additional details are described with respect to FIG. 4), classification results associated with the plurality of candidate digital components (additional details are described with respect to FIG. 5), safety review results associated with the plurality of candidate digital components (additional details are described with respect to FIG. 5), or user feedback associated with the plurality of candidate digital components (additional details are described with respect to FIG. 6).

In some cases, the AI system 160 can store and retrieve the evaluation results, the classification results, the safety review results, and/or the user feedback associated with the plurality of candidate digital components in the evaluation data database 226, the classification data database 230, the safety review data database 228, and/or the user feedback data database 224, respectively.

In some embodiments, the AI system generates, using the training data generation apparatus 212, training data. The training data generation apparatus 212 can be implemented using at least one computing device (e.g., a device including one or more processors), and can include one or more machine learning models.

In some embodiments, the generative model 202 is an unsupervised machine learning model trained using reinforcement learning algorithm(s). Reinforcement learning, also known as RL, is a machine learning approach used to solve problems by maximizing rewards or achieving specific targets through interactions between an agent and an environment, modeled as a Markov decision process (MDP). RL is an unsupervised learning method that relies on sequential feedback (e.g., rewards) from the environment. During the learning process, the agent observes the state of the environment, selects actions based on a policy, and receives feedback in the form of rewards or scores.

Through trial and error, the agent iteratively interacts with the environment, aiming to obtain the maximum reward or reach a specific target. The reward signals from the environment evaluate the quality of the agent's actions rather than guiding the agent on how to make correct actions. As the environment provides limited feedback, the agent learns through experience, acquiring knowledge during interactions, and enhancing its action selection policy to adapt to the environment.

More specifically, the learning process can involve the agent repeatedly observing the state of the environment, making decisions on behavior, and receiving feedback. The objective of this learning can be to achieve an ideal state value function or policy. In some cases, the state value function can represent the expected cumulative rewards attainable by following the policy.

In one example, a state value function can be defined as:

$${V}^{π} ( s ) = {E}_{π} [ {R}_{t} \vert {s}_{t} = s ]$$

In this equation, Rₜ represents a long-term cumulative reward obtained through executing actions based on the policy π. The state value function represents an expectation of a cumulative reward brought by using the policy π starting from the state s.

As an example, assume that the digital components are images and the generative model 202 is trained to generate images based on the query and/or additional query data. The environment's state can include the following elements:
Query and/or additional query data.
Feedbacks on previous generated images: these can be based on, for example, at least one of performance data associated with the plurality of candidate images, evaluation result(s) associated with the plurality of candidate images, classification result(s) associated with the plurality of candidate images, safety review result(s) associated with the plurality of candidate images, or user feedback associated with the plurality of candidate images.
   The state evolves as the generative model 202 iteratively generates images, receives feedback, and updates its policy.

The agent's action can be what the generative model 202 does in response to its current state. In this example, the agent's action can be generating an image based on its current policy, the query and/or additional query data, and the feedbacks on previous generated images. The agent aims to learn a policy that leads to generating images that receive positive feedbacks, thus maximizing the received rewards while minimizing the penalties. The rewards and/or penalties can be determined based on a reward function.

The generative model 202's objective is to learn from these rewards and penalties to improve its digital component generation capabilities iteratively. Over time, the generative model 202 should generate digital components that are more likely to receive positive feedbacks, leading to better digital component generation performance. The reward function, in this case, acts as the “reinforcement signal” that guides the generative model 202's learning process.

In some implementations, when the machine learning model is an unsupervised machine learning model trained using RL algorithm(s), the AI system 160 can include, in the training data, at least one of the identified candidate digital component (e.g., pixels of a generated image), an algorithm for generating the identified candidate digital component, a reward of the identified candidate digital component, an evaluation result of the identified candidate digital component (additional details are described with respect to FIG. 4), a classification result of the identified candidate digital component (additional details are described with respect to FIG. 5), a safety review result of the identified candidate digital component (additional details are described with respect to FIG. 5), or user feedback of the identified candidate digital component (additional details are described with respect to FIG. 6). In some cases, the training data can include other candidate digital component(s) and/or their corresponding data (e.g., other candidate digital component(s), algorithm(s) for generating the other candidate digital component(s), and/or reward(s) of the other candidate digital component(s)).

The algorithm for generating the identified candidate digital component can include, for example, one or more steps associated with generating background images for original images. In some cases, the algorithm for generating the candidate digital component can occupy a smaller memory space than the candidate digital component itself. So, in some cases, including the algorithm for generating the candidate digital component in the training data can save storage space compared to including the entire candidate digital component in the training data.

In some implementations, a reward of a candidate digital component can be generated using a reward function. To output the reward of a candidate digital component, the input(s) to the reward function can include, for example, at least one of the following: acceptance level and/or performance data of the candidate digital component (additional details are described with respect to FIG. 3), an evaluation result of the candidate digital component (additional details are described with respect to FIG. 4), a classification result of the candidate digital component (additional details are described with respect to FIG. 5), a safety review result of the candidate digital component (additional details are described with respect to FIG. 5), or user feedback of the candidate digital component (additional details are described with respect to FIG. 6).

In some examples, the generative model 202 is a supervised machine learning model. The input(s) to the supervised machine learning model can include one or more features, such as an input prompt (e.g., the input prompt 242), a query (e.g., the query 246), and/or the additional query data. The output of the supervised machine learning model can be, for example, a digital component (e.g., an image). The supervised machine learning model can be trained using a set of training data and a corresponding set of labels, where the training data can include multiple sets of data relating to multiple queries and the generated digital components for these queries. For example, a piece of training data can include, as feature(s) of a sample, an input prompt, a query, and/or the additional query data. The label of the piece of training data can be, for example, a digital component having high acceptance level, given the feature(s) of the sample. The machine learning model can be trained by optimizing a loss function based on a difference between the model's output during training and the corresponding label.

The training data generation apparatus 212 can store the generated training data in the training data database 220. For example, the training data database 220 can index the generated training data to the query for which the training data is generated and/or an entity associated with the generated training data, so that the generated training data can be retrieved from the training data database 220 for additional operations performed by the training data generation apparatus 212 and/or the AI system 160.

In some cases, the AI system 160 can refine, using the model refine apparatus 214, the generative model 202 using the training data. The model refine apparatus 214 can be implemented using at least one computing device (e.g., a device including one or more processors), and can include one or more machine learning models. In some cases, the model refine apparatus 214 can refine the generative model 202 immediately upon the occurrence of a particular event. For example, the generative model 202 can be re-trained when an accuracy of the generative model 202 satisfies (meets or below) a predetermined threshold. In some cases, the generative model 202 can be re-trained periodically (e.g., every seven days or thirty days) and/or re-trained when a certain amount of training data has been generated.

In some implementations, after a period of training and/or refining, the generative model 202 can satisfy one or more predetermined conditions. The one or more predetermined conditions can include, for example, an accuracy of the generative model 202 satisfies (meets or exceeds) a predetermined threshold (e.g., the CTRs of images generated by the generative model 202 satisfy predetermined threshold(s)). When the generative model 202 satisfies the one or more predetermined conditions, the AI system 160 can enter the exploitation mode where the AI system 160 can return an output digital component 248 to the client device 204 in response to a query from the client device 204.

FIG. 3 is a flow chart of an example process 300 for refining outputs of generative models based on performance data, according to an implementation of the present disclosure. Operations of the process 300 can be performed, for example, by the service apparatus 110 of FIG. 1, or another data processing apparatus. The operations of the process 300 can also be implemented as instructions stored on a computer readable medium, which can be non-transitory. Execution of the instructions, by one or more data processing apparatus, causes the one or more data processing apparatus to perform operations of the process 300.

At 302, an AI system (e.g., the AI system 160) receives a query. The operation 302 can be similar to the operations associated with receiving the query and the additional query data as described with respect to FIG. 2, and the details are omitted here for brevity.

At 304, the AI system generates, based on the query, a plurality of candidate digital components using a machine learning model (e.g., the generative model 202). The operation 304 can be similar to the operations associated with generating the plurality of candidate digital components as described with respect to FIG. 2, and the details are omitted here for brevity.

At 306, the AI system obtains performance data indicating an acceptance level of each candidate digital component of the plurality of candidate digital components. The operation 306 can be similar to the operations associated with obtaining the performance data as described with respect to FIG. 2, and the details are omitted here for brevity.

At 308, the AI system identifies a candidate digital component of the plurality of candidate digital components having a highest acceptance level. The operation 308 can be similar to the operations associated with identifying the candidate digital component as described with respect to FIG. 2, and the details are omitted here for brevity.

At 310, the AI system generates, based on the candidate digital component, training data. The operation 310 can be similar to the operations associated with generating the training data as described with respect to FIG. 2.

In addition, in some implementations, when the machine learning model is trained using RL algorithm(s), the training data can include a reward of the candidate digital component, and the reward can be generated using a reward function. The reward function can be, for example, a function of the acceptance level and/or performance data. In an example binary reward function, the binary reward function can provide a positive reward (e.g., +1) for a candidate digital component having the highest acceptance level and a negative reward (i.e., a penalty, for example −1) for each other candidate digital component.

In this example, the machine learning model (trained using RL algorithm(s)) would aim to maximize the cumulative reward it receives over time. If a candidate digital component receives positive performance data, the model receives a positive reward. This encourages the model to generate more digital components similar to the one that received positive performance data. For example, this can encourage the model to generate more digital components that can receive high CTR. On the other hand, if a candidate digital component receives negative performance data, the model receives a penalty. This feedback signals the model to avoid generating similar digital components in the future and strive for better results.

At 312, the AI system refines the machine learning model using the training data. The operation 312 can be similar to the operations associated with refining the machine learning model as described with respect to FIG. 2, and the details are omitted here for brevity.

FIG. 4 is a flow chart of an example process 400 for refining outputs of generative models based on performance data and evaluation results, according to an implementation of the present disclosure. Operations of the process 400 can be performed, for example, by the service apparatus 110 of FIG. 1, or another data processing apparatus. The operations of the process 400 can also be implemented as instructions stored on a computer readable medium, which can be non-transitory. Execution of the instructions, by one or more data processing apparatus, causes the one or more data processing apparatus to perform operations of the process 400.

At 402, an AI system (e.g., the AI system 160) receives a query. The operation 302 can be similar to the operations associated with receiving the query and the additional query data as described with respect to FIG. 2, and the details are omitted here for brevity.

At 404, the AI system generates, based on the query, a plurality of candidate digital components using a machine learning model (e.g., the generative model 202). The operation 404 can be similar to the operations associated with generating the plurality of candidate digital components as described with respect to FIG. 2, and the details are omitted here for brevity.

At 406, the AI system obtains evaluation results associated with the plurality of candidate digital components, each evaluation result indicating whether a corresponding candidate digital component includes restricted content. In some cases, each of the plurality of candidate digital components has a corresponding evaluation result, and the evaluation result can include an evaluation score. In some implementations, obtaining the evaluation results can include identifying one or more attributes associated with a candidate digital component, and generating, based on the one or more attributes, an evaluation score of the candidate digital component.

Examples of the one or more attributes include but not limited to whether the candidate digital component includes any clickbait information, whether the candidate digital component includes any illegal or prohibited content (e.g., drug trafficking, piracy, hacking, or other criminal acts), whether the candidate digital component includes any violent or disturbing content, whether the candidate digital component includes any adult or explicit content, whether the candidate digital component includes any hate speech or offensive material, whether the candidate digital component includes any copyrighted material, whether the candidate digital component includes any misleading or deceptive content, whether the candidate digital component includes any gambling or betting information, whether the candidate digital component includes any sensitive topics (e.g., content discussing sensitive topics like self-harm, suicide, or mental health issues), whether the candidate digital component includes any restricted geographic content (e.g., certain content may be geographically restricted due to licensing agreements, legal restrictions, or cultural sensitivities), and whether the candidate digital component includes any political or election-related content.

In some cases, the AI system can input the candidate digital component into additional machine learning model(s) to generate the one or more attributes associated with the candidate digital component. In some cases, one additional machine learning model can generate all the one or more attributes. In some cases, more than one additional machine learning model can be implemented to generate the one or more attributes. In some embodiments, the additional machine learning model(s) can be supervised machine learning model(s). A supervised machine learning model can be trained using a set of training data and a corresponding set of labels, where the training data can include multiple sets of data relating to multiple digital components and their corresponding attributes. For example, a piece of training data can include a digital component as feature values. The label of the piece of training data can be, for example, one or more attributes associated with the digital component. The machine learning model can be trained by optimizing a loss function based on a difference between the model's output during training and the corresponding label.

In some cases, the one or more attributes can be identified by human evaluators. The AI system can transmit the candidate digital component to one or more computing devices associated with one or more human evaluators. In some cases, the human evaluator(s) can review the candidate digital component to identify the one or more attributes (e.g., using a predefined checklist) and transmit the one or more attributes to the AI system. In other cases, the human evaluator(s) can input digitized text that comments on the one or more attributes but does not explicitly list the one or more attributes. For example, instead of saying that the candidate digital component includes clickbait information, the digitized text can describe that the candidate digital component includes intriguing headlines to attract users'attention and encourage them to click on the advertisements to learn more. Under such cases, the AI system can parse the digitized text to identify the one or more attributes associated with the candidate digital component. For example, the digitized text can be analyzed, using a text analysis engine, to generate the one or more attributes associated with the candidate digital component.

In some implementations, the AI system can determine an evaluation score based on the one or more attributes associated with the candidate digital component. In some cases, the evaluation score can be binary. Using the examples of attributes described above, if the candidate digital component includes any of the contents described above, the candidate digital component can have a negative evaluation score (e.g., −1). Otherwise, the candidate digital component can have a positive evaluation score (e.g., +1).

In some cases, the evaluation score is not limited to binary values, but can take on more than two values. For example, the AI system can compute one or more evaluation subscores of the candidate digital component, each evaluation subscore associated with a corresponding attribute of the one or more attributes. The AI system can then combine the one or more evaluation subscores to generate an evaluation score of the candidate digital component. The one or more evaluation subscores can be combined in various ways. In some cases, the one or more evaluation subscores can be summed up to generate the evaluation score. In some cases, the evaluation score can be a weighted sum of the one or more evaluation subscores. The evaluation subscore can be binary (e.g., 1 if no restricted content associated with a corresponding attribute is found, −1 if restricted content associated with a corresponding attribute is found). Alternatively, an evaluation subscore can take on more than two values. For example, an evaluation subscore can represent the quantity or severity of the restricted content associated with an attribute corresponding to the evaluation subscore. So, for example, a high evaluation subscore can represent large quantity of restricted content and/or a high severity of the restricted content, whereas a low evaluation subscore can represent little or none restricted content and/or a low severity of the restricted content.

At 408, the AI system obtains performance data indicating an acceptance level of each candidate digital component of the plurality of candidate digital components. The operation 408 can be similar to the operations associated with obtaining the performance data as described with respect to FIG. 2, and the details are omitted here for brevity.

At 410, the AI system identifies, based on the evaluation results and the performance data, a candidate digital component of the plurality of candidate digital components. In some cases, the performance data can be the primary metric and the evaluation results can be the secondary metric in identifying the candidate digital component. For example, the AI system can rank, as a ranked plurality of candidate digital components, the plurality of candidate digital components from a highest acceptance level to a lowest acceptance level, where the acceptance level is determined based on performance data as described with respect to FIG. 2. The AI system can search, from the beginning of the ranked plurality of candidate digital components, the first candidate digital component, as the candidate digital component, whose evaluation result satisfies a predetermined condition. For example, the predetermined condition can include at least one of the following: a candidate digital component does not include predetermined restricted content (e.g., the example restricted contents described with respect to FIG. 2), or an evaluation score of the candidate digital component satisfies (e.g., meets or exceeds) a predetermined threshold. In some implementations, the evaluation results can be the primary metric and the performance data can be the secondary metric, and similar operations described above can be used to identify the candidate digital component.

In some cases, the AI system can combine the performance data and the evaluation results to generate a ranking for identifying the candidate digital component. For example, for each respective candidate digital component of the plurality of candidate digital components, the AI system can input an evaluation result (e.g., evaluation score) of the respective candidate digital component and an acceptance level of the respective candidate digital component to a reward function to generate a reward for the respective candidate digital component. In some cases, the reward function can be positively correlated with the evaluation results and the performance data. So, for example, a positive evaluation result and/or positive performance data corresponds to a high reward, whereas a negative evaluation result and/or negative performance data corresponds to a low reward.

In some implementations, after generating a reward for each of the plurality of candidate digital components, the AI system can generate a ranking of the plurality of candidate digital components. For example, the AI system can rank the plurality of candidate digital components from a highest reward to a lowest reward. The AI system can then identify the first candidate digital component of the ranking of the plurality of candidate digital components as the candidate digital component.

At 412, the AI system generates, based on the candidate digital component, training data. The operation 412 can be similar to the operations associated with generating the training data as described with respect to FIG. 2.

In addition, in some implementations, when the machine learning model is trained using RL algorithm(s), the training data can include a reward of the candidate digital component, and the reward can be generated using a reward function. In some cases, the reward function can take both of an evaluation result and performance data associated with the candidate digital component as inputs and output the reward of the candidate digital component (similar to the reward function described in operation 410). In some cases, the reward function can take the evaluation result associated with the candidate digital component as input without the performance data and output the reward of the candidate digital component. In some cases, the training data can include an evaluation result (e.g., the evaluation score) of the candidate digital component.

In this example, the machine learning model (trained using RL algorithm(s)) would aim to maximize the cumulative reward it receives over time. If a candidate digital component receives positive evaluation result and/or positive performance data, the model receives a positive reward. This encourages the model to generate more digital components similar to the one that received positive evaluation result and/or positive performance data. For example, this can encourage the model to generate more digital components that can receive high evaluation scores. On the other hand, if a candidate digital component receives negative evaluation result and/or negative performance data, the model receives a penalty. This feedback signals the model to avoid generating similar digital components in the future and strive for better results.

FIG. 5 is a flow chart of an example process 500 for refining outputs of generative models based on performance data and classification results, according to an implementation of the present disclosure. Operations of the process 500 can be performed, for example, by the service apparatus 110 of FIG. 1, or another data processing apparatus. The operations of the process 500 can also be implemented as instructions stored on a computer readable medium, which can be non-transitory. Execution of the instructions, by one or more data processing apparatus, causes the one or more data processing apparatus to perform operations of the process 500.

At 502, an AI system (e.g., the AI system 160) receives a query. The operation 502 can be similar to the operations associated with receiving the query and the additional query data as described with respect to FIG. 2.

In addition, in some cases, the query can indicate an intended category of a digital component to generate. For example, assuming that the digital components are advertisements, the advertisements can be classified based on a product or a service promoted by the advertisement. The intended categories can include, for example, “kids,” “gambling,” and “adult content.” Assume that the query is used to generate an advertisement for a toy, the intended category of the digital component can be “kids.”

In some implementations, the AI system can infer the intended category of the digital component based on the query and/or the additional query data using, for example, semantic analysis. For example, the AI system can use semantic analysis to parse the query and/or the additional query data to generate a summary of the digital component to be generated, which can include an intended category. In some cases, the additional query data can indicate the intended category. In some cases, a human evaluator can provide the intended category by reviewing the query and/or the additional query data.

At 504, the AI system generates, based on the query, a plurality of candidate digital components using a machine learning model (e.g., the generative model 202). The operation 504 can be similar to the operations associated with generating the plurality of candidate digital components as described with respect to FIG. 2, and the details are omitted here for brevity.

At 506, the AI system obtains classification results associated with the plurality of candidate digital components using a classification model, where each classification result indicates whether a category of a corresponding candidate digital component corresponds to the intended category. In some cases, the classification model can be trained to classify digital components (e.g., based on the subject matter included in a generated advertisement). The AI system can input each candidate digital component into the machine learning model to generate a category of the candidate digital component. The classification result can be generated based on determining whether the category of the candidate digital component corresponds to the intended category (e.g., by comparing the category of the candidate digital component and the intended category).

In some cases, the classification result can be binary. For example, if the category of the candidate digital component is identical to the intended category, the classification result can be a positive value (e.g., +1). Otherwise, the classification result can be a negative value (e.g., −1). For example, assume that the intended category is “kids.” If the category of a candidate digital component is also “kids,” the classification result of the candidate digital component can be a positive value. On the other hand, if the category of a candidate digital component is “adult contents,” the classification result of the candidate digital component can be a negative value.

In some cases, the classification result is not limited to binary values, but can take on more than two values. For example, the classification result can represent the proximity of the intended category and the category of the candidate digital component. So, for example, a large value of a classification result can represent a high proximity of the intended category and the category of the candidate digital component, whereas a small value of a classification result can represent a low proximity of the intended category and the category of the candidate digital component. For example, assuming that the intended category is “gambling,” the category of a first candidate digital component is “kids,” and the category of a second candidate digital component is “adult content.” The classification result of the second candidate digital component can be greater than the classification result of the first candidate digital component because “adult content” is more proximate than “kids” to “gambling.”

In some cases, determining whether the category of the candidate digital component corresponds to the intended category can include inputting the candidate digital component and the intended category into an additional machine learning model to determine whether the category of the candidate digital component corresponds to the intended category. The additional machine learning model can be trained to determine whether a category of a candidate digital component corresponds to an intended category.

In some cases, in addition to the classification results, the AI system can obtain safety review results associated with the plurality of candidate digital components, where each safety review result indicates whether a corresponding candidate digital component violates a safety policy. Assuming that the digital components are advertisements, the safety policies can include regulations and policies put in place to protect consumers, maintain fair competition, and ensure that advertisements are truthful, ethical, and safe. In some cases, the safety policies can vary across different countries and regions. Some common types of the safety policies include truth in advertising, consumer protection, advertising to children, and tobacco and alcohol advertising.

In some examples, obtaining the safety review results can include identifying, based on the intended category, one or more safety policies. In some cases, the AI system can maintain mapping relationships between the intended categories and the safety policies. An intended category can have mapping relationship(s) with one or more safety policies. For example, the “kids” category can be mapped to Children's Online Privacy Protection Act (COPPA) and Children's Television Act. The AI system can use the mapping relationships to identify the one or more safety policies.

Then the AI system can determine whether a candidate digital component violates at least one of the one or more safety policies. In some implementations, an automatic review process can be implemented to determine whether the candidate digital component violates at least one of the one or more safety policies. For example, the AI system can input the candidate digital component and the one or more safety policies into an additional machine learning model to determine whether the candidate digital component violates at least one of the one or more safety policies. In some implementations, one or more human reviewers can determine whether the candidate digital component violates at least one of the one or more safety policies.

In some cases, if the AI system determines that the candidate digital component does not violate any of the one or more safety policies, the AI system can generate a positive safety review result for the candidate digital component. On the other hand, if the AI system determines that the candidate digital component violates at least one of the one or more safety policies, the AI system can generate a negative safety review result for the candidate digital component.

At 508, the AI system obtains performance data indicating an acceptance level of each candidate digital component of the plurality of candidate digital components. The operation 508 can be similar to the operations associated with obtaining the performance data as described with respect to FIG. 2, and the details are omitted here for brevity.

At 510, the AI system identifies, based on the classification results and the performance data, a candidate digital component. In some cases, the performance data can be the primary metric and the classification results can be the secondary metric in identifying the candidate digital component. For example, the AI system can rank, as a ranked plurality of candidate digital components, the plurality of candidate digital components from a highest acceptance level to a lowest acceptance level, where the acceptance level is determined based on performance data as described with respect to FIG. 2. The AI system can search, from the beginning of the ranked plurality of candidate digital components, the first candidate digital component, as the candidate digital component, whose category corresponds to the intended category. In some implementations, the classification results can be the primary metric and the performance data can be the secondary metric, and similar operations described above can be used to identify the candidate digital component.

In some cases, the AI system can combine the performance data and the classification results to generate a ranking for identifying the candidate digital component. For example, for each respective candidate digital component of the plurality of candidate digital components, the AI system can input a classification result of the respective candidate digital component and an acceptance level of the respective candidate digital component to a reward function to generate a reward for the respective candidate digital component. In some cases, the reward function can be positively correlated with the classification results and the performance data. So, for example, a positive classification result and/or positive performance data corresponds to a high reward, whereas a negative classification result and/or negative performance data corresponds to a low reward.

In some implementations, after generating a reward for each of the plurality of candidate digital components, the AI system can generate a ranking of the plurality of candidate digital components. For example, the AI system can rank the plurality of candidate digital components from a highest reward to a lowest reward. The AI system can then identify the first candidate digital component of the ranking of the plurality of candidate digital components as the candidate digital component.

In some embodiments, in addition to the classification results and the performance data, the AI system can identify the candidate digital component further based on the safety review results. This can be implemented using similar operations described above with respect to identifying the candidate digital component based on the classification results and the performance data, and the details are omitted here for brevity.

At 512, the AI system generates, based on the candidate digital component, training data. The operation 512 can be similar to the operations associated with generating the training data as described with respect to FIG. 2.

In addition, in some implementations, when the machine learning model is trained using RL algorithm(s), the training data can include a reward of the candidate digital component, and the reward can be generated using a reward function. In some cases, the reward function can take at least one of a classification result, a safety review result, or performance data associated with the candidate digital component as input(s), and output the reward of the candidate digital component. In some cases, the training data can include at least one of a classification result of the candidate digital component or a safety review result of the candidate digital component.

In this example, the machine learning model (trained using RL algorithm(s)) would aim to maximize the cumulative reward it receives over time. If a candidate digital component receives positive classification result, positive safety review result, and/or positive performance data, the model receives a positive reward. This encourages the model to generate more digital components similar to the one that received positive classification result, positive safety review result, and/or positive performance data. For example, this can encourage the model to generate more digital components whose categories correspond to the intended categories and/or do not violate any safety policy. On the other hand, if a candidate digital component receives negative classification result, negative safety review result, and/or negative performance data, the model receives a penalty. This feedback signals the model to avoid generating similar digital components in the future and strive for better results.

FIG. 6 is a flow chart of an example process 600 for refining outputs of generative models based on performance data and user feedback, according to an implementation of the present disclosure. Operations of the process 600 can be performed, for example, by the service apparatus 110 of FIG. 1, or another data processing apparatus. The operations of the process 600 can also be implemented as instructions stored on a computer readable medium, which can be non-transitory. Execution of the instructions, by one or more data processing apparatus, causes the one or more data processing apparatus to perform operations of the process 600.

At 602, an AI system (e.g., the AI system 160) receives a query. The operation 602 can be similar to the operations associated with receiving the query and the additional query data as described with respect to FIG. 2, and the details are omitted here for brevity.

At 604, the AI system generates, based on the query, a plurality of candidate digital components using a machine learning model (e.g., the generative model 202). The operation 604 can be similar to the operations associated with generating the plurality of candidate digital components as described with respect to FIG. 2, and the details are omitted here for brevity.

At 606, the AI system obtains user feedback associated with the plurality of candidate digital components, each user feedback indicating a user preference level of a corresponding candidate digital component. In some cases, each of the plurality of candidate digital components has a corresponding user feedback provided by user(s) (e.g., advertiser(s)) about their experience, opinions, and satisfaction with the candidate digital component. In some implementations, obtaining the user feedback can include identifying one or more attributes associated with a candidate digital component, and generating, based on the one or more attributes, a user preference level of the candidate digital component.

The one or more attributes can be associated with, for example, style, color, formats, length, placement (e.g., social media, search engine, and mobile), language and tone, call-to-action, use of social proof, inclusivity and diversity, and restricted content. Example of restricted contents are similar to those described with respect to FIG. 4 and are omitted here for brevity. For example, the user feedback can indicate that a user likes a digital component because it includes a background image depicting Fuji Mountain, but they dislike the color of the background image. The attribute(s) can then include, for example, “good subject matter in the background image” and “bad color of the background image.”

In some cases, the AI system can input the user feedback into additional machine learning model(s) to generate the one or more attributes associated with the candidate digital component. In some cases, one additional machine learning model can generate all the one or more attributes. In some cases, more than one additional machine learning model can be implemented to generate the one or more attributes. In some embodiments, the additional machine learning model(s) can be supervised machine learning model(s). A supervised machine learning model can be trained using a set of training data and a corresponding set of labels, where the training data can include multiple sets of data relating to multiple user feedback and their corresponding attributes. For example, a piece of training data can include a piece of user feedback as feature values. The label of the piece of training data can be, for example, one or more attributes associated with the digital component. The machine learning model can be trained by optimizing a loss function based on a difference between the model's output during training and the corresponding label.

In some cases, the AI system can analyze, using a text analysis engine, digitized text representing the user feedback to generate the one or more attributes associated with the candidate digital component. This can be based on similar operations with respect to analyzing the digitized text as described in FIG. 4, and the details are omitted here for brevity.

In some implementations, the AI system can determine a user preference level based on the one or more attributes associated with the candidate digital component. In some cases, the user preference level can be a binary value. For example, the user feedback can indicate a first quantity of attribute(s) that the user indicated as positive and a second quantity of attribute(s) that the user indicated as negative. If the first quantity is greater than the second quantity, the user preference level can have a positive value (e.g., +1). On the other hand, if the first quantity is smaller than or equal to the second quantity, the user preference level can have a negative value (e.g., −1).

In some cases, the user preference level is not limited to binary values but can take on more than two values. For example, the AI system can compute one or more user subscores of the candidate digital component, each user subscore associated with a corresponding attribute of the one or more attributes. The AI system can then combine the one or more user subscores to generate the user preference level of the candidate digital component. The one or more user subscores can be combined in various ways. In some cases, the one or more user subscores can be summed up to generate the user preference level. In some cases, the user preference level can be a weighted sum of the one or more user subscores. The user subscore can be binary (e.g., 1 if the user likes an attribute, −1 if the user dislikes an attribute). Alternatively, the user subscore can take on more than two values. For example, the user subscore can represent the extent or intensity to which the user likes an attribute. So, for example, “much like” can correspond to a subscore of 2, “like” can correspond to a subscore of 1, “neutral” can correspond to a subscore of 0, “dislike” can correspond to a subscore of −1, and “much dislike” can correspond to a subscore of −2.

At 608, the AI system obtains performance data indicating an acceptance level of each candidate digital component of the plurality of candidate digital components. The operation 608 can be similar to the operations associated with obtaining the performance data as described with respect to FIG. 2, and the details are omitted here for brevity.

At 610, the AI system identifies, based on the user feedback and the performance data, a candidate digital component. In some cases, the performance data can be the primary metric and the user feedback can be the secondary metric in identifying the candidate digital component. For example, the AI system can rank, as a ranked plurality of candidate digital components, the plurality of candidate digital components from a highest acceptance level to a lowest acceptance level, where the acceptance level is determined based on performance data as described with respect to FIG. 2. The AI system can search, from the beginning of the ranked plurality of candidate digital components, the first candidate digital component, as the candidate digital component, whose user feedback satisfies a predetermined condition. For example, the predetermined condition can include at least one of the following: a candidate digital component does not include predetermined restricted content (e.g., the example restricted content described with respect to FIG. 2), or a user preference level of the candidate digital component satisfies (e.g., meets or exceeds) a predetermined threshold. In some implementations, the user feedback can be the primary metric and the performance data can be the secondary metric, and similar operations described above can be used to identify the candidate digital component.

In some cases, the AI system can combine the performance data and the user feedback to generate a ranking for identifying the candidate digital component. For example, for each respective candidate digital component of the plurality of candidate digital components, the AI system can input the user preference level of the respective candidate digital component and the performance data of the respective candidate digital component to a reward function to generate a reward for the respective candidate digital component. In some cases, the reward function can be positively correlated with the user feedback and the performance data. So, for example, a positive user feedback and/or positive performance data corresponds to a high reward, whereas a negative user feedback and/or negative performance data corresponds to a low reward.

In some implementations, after generating a reward for each of the plurality of candidate digital components, the AI system can generate a ranking of the plurality of candidate digital components. For example, the AI system can rank the plurality of candidate digital components from a highest reward to a lowest reward. The AI system can then identify the first candidate digital component of the ranking of the plurality of candidate digital components as the candidate digital component.

At 612, the AI system generates, based on the candidate digital component, training data. The operation 612 can be similar to the operations associated with generating the training data as described with respect to FIG. 2.

In addition, in some implementations, when the machine learning model is trained using RL algorithm(s), the training data can include a reward of the candidate digital component generated using a reward function. In some cases, the reward function can take both of a user preference level and the performance data associated with the candidate digital component as inputs and output the reward of the candidate digital component (similar to the reward function described in operation 610). In some cases, the reward function can take the user preference level associated with the candidate digital component as input without the performance data and output the reward of the candidate digital component. In some cases, the training data can include the user feedback and/or the user preference level of the candidate digital component.

In this example, the machine learning model (trained using RL algorithm(s)) would aim to maximize the cumulative reward it receives over time. If a candidate digital component receives positive user feedback and/or positive performance data, the model receives a positive reward. This encourages the model to generate more digital components similar to the one that received positive user feedback and/or positive performance data. For example, this can encourage the model to generate more digital components that can receive high user preference levels. On the other hand, if a candidate digital component receives negative user feedback and/or negative performance data, the model receives a penalty. This feedback signals the model to avoid generating similar digital components in the future and strive for better results.

In some implementations, the AI system can proactively obtain information from one or more data sources as user feedback, even when the user did not directly provide any user feedback. For example, the AI system can automatically identify, based on an identity of an entity associated with the query, a source including information about the entity, obtain the information about the entity from the source, and parse, based on a semantic analysis, the information about the entity to generate one or more entity attributes associated with the entity. The one or more entity attributes can indicate, for example, the entity's preference(s) for digital components. These operations can be similar to the operations with respect to obtaining one or more entity attributes in the additional query data as described in FIG. 2, and the details are omitted here for brevity.

Using the one or more entity attributes, the AI system can generate an additional candidate digital component and recommend the additional candidate digital component to the entity. For example, the AI system can adjust a previously generated digital component according to the one or more entity attributes (e.g., to satisfy the entity's preferences) and recommend the adjusted digital component to the entity.

For example, an entity can be a clothes retailer. The AI system can generate multiple candidate advertisements and identify an advertisement based on the user feedback of the clothes retailer. The user feedback of the clothes retailer can indicate that the clothes retailer prefers an advertisement style that is suitable for the fashion clothes sector. After a period of time, the clothes retailer's preference(s) for digital components can change but may fail to notify the AI system about their changed preference(s). For example, the clothes retailer may expand their business to kids'clothes and may prefer another advertisement style that is suitable for the kids'clothes sector. Without being notified of this change, the AI system can obtain the clothes retailer's updated preference(s) based on tracking continuously data sources that can indicate the clothes retailer's preference(s). For example, the AI system can obtain information from the clothes retailer's landing page. Based on analyzing the obtained information, the AI system can determine that the clothes retailer has expanded their business into the kids'clothes market. Accordingly, the AI system can adjust the previously generated advertisement for fashion market to another advertisement that is suitable for kids'clothes and recommend the adjusted advertisement to the clothes retailer.

In some cases, the AI system can protect the privacy of the training data. For example, the training data cannot be accessed by other entities and/or cannot be used to train machine learning model(s) whose results can be accessed by other entities. In some cases, the AI system can train a base machine learning model using general training data that is allowed to be accessed by others. When an entity requests not to distribute their training data (including, for example, their user feedback), the AI system can obtain an instance of the base machine learning model and provide this instance as a private machine learning model to the entity. Training data associated with the entity can be used to train the private machine learning model but cannot be used to train other model(s) such as the base machine learning model. By training in this manner, the private machine learning model can be trained to provide personalized recommendations to the entity, as well as protecting privacy of training data.

FIG. 7 is a flow chart of an example process 700 for generating digital components subject to compliance constraints, according to an implementation of the present disclosure. Operations of the process 700 can be performed, for example, by the service apparatus 110 of FIG. 1, or another data processing apparatus. The operations of the process 700 can also be implemented as instructions stored on a computer readable medium, which can be non-transitory. Execution of the instructions, by one or more data processing apparatus, causes the one or more data processing apparatus to perform operations of the process 700.

At 702, an AI system (e.g., the AI system 160) obtains input data prior to receiving a query. In some cases, the AI system can obtain input data (e.g., a request initiated by a user) and generate, based on the input data, candidate digital component(s) using an offline process (e.g., prior to receiving the query). Contrasting with the online process, where a user can input a query (e.g., a prompt) and obtain real-time results, in the offline process, the AI system can obtain input data from a user and/or other source(s), generate results in the background, and provide the results to the user after a certain period. For example, a user can transmit a request and/or provide additional input data to the AI system in an interactive session. The interactive session can terminate before the AI system returns results to the user. The AI system can then generate results based on the user's input data and return the results to the user after a certain period (e.g., one day, three days, or seven days).

In some cases, a user can indicate to the AI system to operate in an offline mode. For example, the user can initiate a request to the AI system and indicate in the request that the AI system can return results after a certain period. In some cases, the AI system can infer from the user's request that the request may be fulfilled in an offline mode. For example, the user can request to generate background images for a promotion event on Saint Patrick's Day when there is still a period of time remaining before the Saint Patrick's Day. The AI system can infer that the user may accept a delay of receiving the results and thus an offline mode may be acceptable to the user. In such case, the AI system can suggest to the user to generate the background images offline, and the user can accept or reject the suggestion.

The offline process can achieve significant technical advantages. For example, the offline process can reduce the amount of computing, storage, and networking resources reserved for generating the digital components. The amount of user queries can fluctuate significantly from peak times to down times. In the case of online process, computing, storage, and networking resources are typically provisioned and reserved sufficiently enough to handle the amount of queries at peak times. However, these resources can sit idle during non-peak times and thus, the usage efficiencies of these resources can be low. By contrast, in the case of offline process, some user queries can be processed offline during non-peak times. Accordingly, the computing, storage, and networking resources can be lower than that required for the peak times (e.g., reserving resources sufficiently enough to handle average user demands, instead of reserving resources for peak times), and the usage efficiencies of these resources can be improved.

At 704, the AI system generates, based on the input data, one or more candidate digital components using a machine learning model. In some cases, generating the one or more candidate digital components using the machine learning model can include generating, by the AI system, a prompt including the input data. The AI system can input the prompt into the machine learning model, and the machine learning model can generate the one or more candidate digital components. In some implementations, generating the prompt can include obtaining, by the AI system, additional input data including data different from the input data, where the additional input data limits digital components generated by the machine learning model. The AI system can generate the prompt including the input data and the additional input data. In some cases, the additional input data can be similar to the additional query data as described with respect to FIG. 2, and the operation 704 can be similar to the operations associated with generating the plurality of candidate digital components as described with respect to FIG. 2, so the details are omitted here for brevity.

At 706, the AI system obtains user preference data limiting usage of at least one candidate digital component of the one or more candidate digital components. In some cases, the user preference data indicates at least one of a serving time period, a geographical location, or an event that the user consents to use the at least one candidate digital component of the one or more candidate digital components. In one example, a user can specify that the at least one candidate digital component is limited to be served in a particular serving time period (e.g., particular days, weeks, or months). In another example, the user can specify that the at least one candidate digital component is limited to be served in one or more particular geographical locations, such as the geographical location(s) that the user intended to promote a product and/or service associated with the at least one candidate digital component. In yet another example, the user can specify that the at least one candidate digital component is limited to be served for one or more particular events, such as particular holiday(s), shopping season(s), deal day(s), or other types of events.

At 708, the AI system receives a query. The operation 708 can be similar to the operations associated with receiving the query and the additional query data as described with respect to FIG. 2, and the details are omitted here for brevity.

In some cases, before receiving the query, the AI system can obtain one or more basic regulation review results associated with the one or more candidate digital components, where each basic regulation review result indicates whether a corresponding candidate digital component violates a basic digital component regulation. In some cases, a basic digital component regulation can specify that a candidate digital component shall not include any restricted content, and the basic regulation review result can indicate whether a candidate digital component includes any restricted content. Examples of restricted content include but not limited to clickbait information, illegal or prohibited content (e.g., drug trafficking, piracy, hacking, or other criminal acts), violent or disturbing content, adult or explicit content, hate speech or offensive material, copyrighted material, misleading or deceptive content, gambling or betting information, sensitive topics (e.g., content discussing sensitive topics like self-harm, suicide, or mental health issues), restricted geographic content (e.g., certain content may be geographically restricted due to licensing agreements, legal restrictions, or cultural sensitivities), and political or election-related content.

In some cases, obtaining, by the AI system, the one or more basic regulation review results associated with the one or more candidate digital components includes inputting a candidate digital component and one or more basic digital component regulations into an additional machine learning model to determine whether the candidate digital component violates at least one of the one or more basic digital component regulations. In some embodiments, the additional machine learning model can be a supervised machine learning model. The supervised machine learning model can be trained using a set of training data and a corresponding set of labels, where the training data can include multiple sets of data relating to multiple digital components and basic digital component regulations. For example, a piece of training data can include a digital component and one or more basic digital component regulations as feature values. The label of the piece of training data can be, for example, a basic regulation review result associated with the digital component. The machine learning model can be trained by optimizing a loss function based on a difference between the model's output during training and the corresponding label.

In some cases, the basic regulation review results can be identified by human evaluators. The AI system can transmit the candidate digital component to one or more computing devices associated with one or more human evaluators. In some cases, the human evaluator(s) can review the candidate digital component and the basic digital component regulation(s) to determine the basic regulation review result of the candidate digital component. Each of the human evaluator(s) can then transmit the determined basic regulation review result to the AI system.

In some implementations, the AI system can determine whether a basic regulation review result indicates that a candidate digital component violates a basic digital component regulation. In response to determining that the basic regulation review result indicates that the candidate digital component violates the basic digital component regulation, the AI system can remove the candidate digital component from the one or more candidate digital components. In response to determining that the basic regulation review result indicates that the candidate digital component does not violate any basic digital component regulation, the AI system can keep the candidate digital component in the one or more candidate digital components. In some examples, the operations associated with obtaining a basic regulation review result associated with a candidate digital component and excluding/including the candidate digital component based on the basic regulation review result can occur right after the candidate digital component is generated. Therefore, the candidate digital component that violates basic digital component regulation(s) can be identified early and excluded from being processed in the subsequent steps. Thereby, the computing, storage, and networking resources associated with processing the candidate digital component can be reduced.

At 710, the AI system identifies one or more digital component regulations associated with the query. In some cases, the digital component regulation can be similar to the safety policy as described with respect to FIG. 5, and the operation 710 can be similar to the operations associated with identifying the safety policies as described with respect to operation 506 in FIG. 5, so the details are omitted here for brevity.

In some implementations, the digital component regulation can be different from the basic digital component regulation described with respect to operation 708. For example, a basic digital component regulation can include law(s) that are common in more than one states, whereas a digital component regulation can be a specific state law that is enforceable in a particular state. Therefore, in some cases, a candidate digital component does not violate any basic digital component regulation but can violate a digital component regulation. For example, a candidate digital component can include gambling content. The basic digital component regulation(s) may not prohibit a candidate digital component from containing any gambling content. Accordingly, the basic regulation review result can be positive, indicating that the candidate digital component does not violate any basic digital component regulation. However, if the query indicates that the candidate digital component is to be served in a state where gambling is prohibited, the candidate digital component can violate the digital component regulation. On the contrary, if the query indicates that the candidate digital component is to be served in a state where gambling is permissible, the candidate digital component does not violate the digital component regulation.

At 712, the AI system identifies, based on the one or more digital component regulations and the user preference data, at least one particular candidate digital component of the one or more candidate digital components. In some cases, the AI system can identify the at least one candidate digital component to serve the query, and the candidate digital component(s) can include those complying with the one or more digital component regulations and the user preference data. Accordingly, the operation 712 can include, for example, determining whether a candidate digital component complies with the one or more digital component regulations and the user preference data. In response to determining that a candidate digital component does not comply with the one or more digital component regulations or the user preference data, the candidate digital component can be excluded from serving the query. On the contrary, in response to determining that a candidate digital component complies with the one or more digital component regulations and the user preference data, the candidate digital component may be used to serve the query.

In some implementations, determining whether the candidate digital component complies with the one or more digital component regulations and the user preference data can include inputting the candidate digital component, the one or more digital component regulations, and the user preference data into an additional machine learning model to determine whether the candidate digital component complies with the one or more digital component regulations and the user preference data. In some embodiments, the additional machine learning model can be a supervised machine learning model. The supervised machine learning model can be trained using a set of training data and a corresponding set of labels, where the training data can include multiple sets of data relating to multiple digital components, digital component regulations, and user preference data. For example, a piece of training data can include a digital component, one or more digital component regulations, and user preference data as feature values. The label of the piece of training data can be, for example, a result indicating whether the digital component should be included in or excluded from the output. The machine learning model can be trained by optimizing a loss function based on a difference between the model's output during training and the corresponding label.

In some cases, in addition to the digital component regulations and the user preference data, performance data (similar to the performance data described with respect to FIG. 2) can be used to identify the at least one particular candidate digital component. For example, the candidate digital component(s) complying with the digital component regulation(s) and the user preference data can first be identified. Then, the candidate digital component(s) can be ranked based on their acceptance levels as indicated by the performance data. The at least one particular candidate digital component can be those ranked the highest among the ranked candidate digital component(s).

In some implementations, the AI system can share with the user the results associated with the candidate digital components, such as the basic regulation review results, the performance data, and/or the particular candidate digital component(s) identified for generating the outputs. In some cases, the user can review the data and identify one or more potential deficiencies of the results. In one example, the user can identify that a basic regulation review result generated by the AI system is incorrect. In such case, the user can notify the AI system to correct the basic regulation review result. In another example, the user can request to replace one or more of the particular candidate digital component(s) with other candidate digital component(s) that the user believes are more suitable for generating the outputs.

At 714, the AI system generates, based on the at least one particular candidate digital component of the one or more candidate digital components, an output digital component. In some cases, the AI system can include the at least one particular candidate digital component in the output digital component. For example, a particular candidate digital component can be a background image and another particular candidate digital component can be a foreground object. The AI system can combine the background image and the foreground object to generate the output digital component. In some cases, the AI system can transmit the output digital component to a computing device associated with the suer. In some cases, the AI system can serve the output digital component by using a digital component serving apparatus (e.g., the DC serving apparatus 210).

FIG. 8 is a block diagram 800 illustrating interactions between an AI system and a client device for using autonomous agents to create and process tasks, according to an implementation of the present disclosure. In some situations, the AI system 802 and the client device 804 can, respectively, be the same or similar to the AI system 160 and client device 106 of FIG. 1.

The client device 804 can transmit a query 806 to the AI system 802. In some cases, the query 806 can be a request for the AI system 802 to generate and/or execute tasks associated with promoting a product or a service (e.g., an advertisement campaign or a marketing event). In some cases, the AI system 802 can provide more than one level of automation for a user to choose from. For example, the AI system 802 can provide a manual mode, a semi-automatic mode, and an automatic mode. In the manual mode, the query 806 can include specific tasks intended to be executed by the AI system 802. For example, the query 806 can include descriptions or images of a product for the AI system 802 to generate an advertisement of the product. By contrast, in the automatic mode, the query 806 does not include detailed inputs such as product descriptions or images. Instead, the query 806 can just include a business objective, key performance indicator(s), and/or desired results to guide the AI system 802 in fulfilling the user's expectations. For example, the query 806 can include a prompt such as “increasing the sale of product X by Y % within a budget of Z” or “here are all my products, I want an overall revenue of X.” In the automatic mode, in addition to generating task(s), the AI system 802 can automatically execute the generated task(s). The semi-automatic mode can be similar to the automatic mode, except that, under the semi-automatic mode, the task(s) generated by the AI system 802 need approval from the user to be subsequently executed.

In some cases, the query 806 can include target audience, preferred tone and style, industry jargon, and/or other type of input for guiding the AI system 802 in fulfilling the user's expectations. In some cases, the query 806 can include historical data (e.g., historical campaign performance data) to enable the AI system 802 to recognize trends, patterns, and areas requiring improvements.

In some examples, the task creation agent 808 can generate, based on the query 806, one or more tasks based on the query 806 and/or request additional input from the user for generating task(s). In some implementations, the task creation agent 808 can generate an input prompt using the query 806. The task creation agent 808 can transmit the input prompt to a generative model, which can then generate, based on the input prompt, one or more tasks associated with the query 806. These operations can be similar to operations associated with generating the input prompt and generating digital components using the input prompt as described with respect to FIG. 2, and the details are omitted here for brevity.

In some cases, after receiving the one or more tasks generated by the generative model, the task creation agent 808 can generate one or more sub-tasks of a task. In some examples, the task creation agent 808 can include a set of sub-agents, each sub-agent configured to generate one or more sub-tasks. For example, the task creation agent 808 can include an image creation sub-agent configured to generate image-related sub-tasks (e.g., sub-tasks associated with generating background and foreground images used in advertisements), a text creation sub-agent configured to generate text-related sub-tasks (e.g., text used in advertisements), a video creation sub-agent configured to generate video-related sub-tasks (e.g., videos used in advertisements), a digital component enhancement sub-agent configured to generate digital component enhancement-related sub-tasks, and/or a budget controlling sub-agent configured to generate budget control-related sub-tasks. After receiving a task generated by the generative model, the task creation agent 808 can determine whether to generate sub-task(s) for the task. If the task creation agent 808 determines to generate sub-task(s) for the task, the task creation agent 808 can identify one or more sub-agents to generate the sub-task(s). For example, a query can include “increasing the sale of product X by Y % within a budget of Z.” The generative model can generate one or more tasks for the query, including a task of “generating an advertisement for product X.” After receiving this task, the task creation agent 808 can determine that sub-tasks are needed to fulfill this task. The task creation agent 808 can identify the image creation sub-agent, the text creation sub-agent, and the digital component enhancement sub-agent for generating the sub-tasks and input the task of “generating an advertisement for product X” to the sub-agents. The image creation sub-agent, the text creation sub-agent, and the digital component enhancement sub-agent can then generate, for example, the sub-tasks of generating a background image, generating a text, and enhancing the advertisement, respectively.

In some implementations, the AI system 802 can provide more than one options of granularity for the task generations. For example, the AI system 802 can provide a coarse granularity mode and a fine granularity mode, where the fine granularity allows to generate more detailed and specific tasks than the coarse granularity mode.

In some cases, the AI system 802 can provide an interface for users to interact with the AI system 802. For example, the AI system 802 can display, using the interface, a set of tasks and/or sub-tasks created by the autonomous agents (e.g., the task creation agent 808 and/or the sub-agents). The interface can enable a user to check or uncheck tasks and/or subtasks. In some cases, the created tasks can be presented as graphs and/or trees.

In some implementations, the AI system 802 can determine that more information is needed from the user before the AI system 802 can generate any task/sub-tasks. Accordingly, the AI system 802 can transmit a request to the client device 804 to request more information. For example, the AI system 802 can receive a query of “boost my ice cream sale with online ads.” The AI system 802 can determine that it needs to understand the current state of the ice cream business and what tasks need be completed to achieve the marketing goals. Accordingly, the AI system 802 can transmit to the client device a request of “I need more information about what task to perform next. Can you provide me with more context?”

In some cases, the AI system 802 can store the generated task(s)/sub-tasks(s) in task queue(s) 810. In some cases, there are more than one task queues (e.g., queue A 812 to queue Z 814), and each task queue is configured to store the task(s)/sub-task(s) of a certain type. For example, the task queues can include a format task queue configured to store format tasks, a targeting task queue configured to store targeting tasks, and a bidding task queue configured to store bidding tasks.

In some implementations, a task prioritization agent 820 can retrieve the unprioritized tasks 818 from the task queues 810, prioritize the tasks, and generate a prioritized task list indicating a sequence of executing the tasks. In some cases, the task prioritization agent 820 can store the prioritized tasks 828 and/or the prioritized task list in the task queues 810. In some cases, the task prioritization agent 820 can transmit the prioritized tasks 828 and/or the prioritized task list to the execution agent 830 directly (not shown). In some implementations, the task prioritization agent 820 can retrieve task prioritization configurations 826 from a task prioritization configuration database 824. The task prioritization configurations 826 can include, for example, one or more rules for prioritizing the tasks.

The tasks can be prioritized based on various rules. In some cases, the tasks can be prioritized based on the tasks'dependency relationships. For example, assume that three tasks are to be prioritized: the first task is generating an image for an advertisement, the second task is generating a text for the advertisement, the third task is allocating the budget for the advertisement. The first and the second tasks can be prioritized over the third task because an advertisement needs to be created first before considering how much budget is allocated to the advertisement. In some cases, the tasks can be prioritized based on the tasks'timing constraints. For example, assume that a task is extracting information from an advertisement campaign and using the information to retrain the generative model. Since the model retraining can take some time, this task can be prioritized so enough time can be provided to retrain the model. In some implementations, after the task prioritization agent 820 generates a prioritized task list, the AI system 802 can transmit the prioritized task list to the client device 804, so the user can review, edit, and/or approve the prioritized task list.

In some cases, the execution agent 830 can obtain the prioritized tasks 828 from the task queues 810 or the task prioritization agent 820 and execute the prioritized tasks 828. In some cases, after executing a task, the execution agent 830 can transmit the task and its execution result (e.g., in the form of <task, result> pair 832) to a memory 836 (which can be operationally and/or structurally similar to the memory structure 232) for storage. The executed task and its execution result can be a part of the context data stored by the memory 836. Additionally, the memory 836 can store other context data, including, for example, performance data (e.g., the performance data described with respect to FIG. 2), information for executing a task, or other type of context data.

In some implementations, the execution agent 830 can transmit a query 834 for context data to the memory 836 to retrieve the context data 838. The context data 838 can be used by the execution agent 830 to execute tasks. In one example, the execution agent 830 cannot execute a task unless its preceding task(s) have been completed. The execution agent 830 can retrieve information about the completed tasks—which can be a part of the context data 838—from the memory 836 and use the context data to determine whether a task can be executed. In another example, a task to be executed can be serving an advertisement, and the context data 838 can include information for executing the serving, such as information from the publisher side, information from the client side, or other type of information. In yet another example, the context data 838 can include performance data of an advertisement campaign. The execution agent 830 can use the performance data to determine whether the advertisement campaign has been completed. For example, assume that the task is to increase the CVR by 5%. If the performance data indicates that the CVR has been increased by 5%, the execution agent 830 can determine that the advertisement campaign has completed.

In some implementations, the execution agent 830 can transmit the task execution results 840 to the task creation agent 808. Additionally, the task creation agent 808 can transmit a query 842 for context data to the memory 836 to obtain context data 844. The task creation agent 808 can use the task execution results 840 and/or the context data 844 to generate one or more additional tasks. For example, if the task execution results 840 indicate that an advertisement campaign has been completed, the task creation agent 808 can create another task for an additional advertisement campaign at a future date.

In some cases, a summarization agent 846 can retrieve context data 848 from the memory 836, generate a summary 850 using the context data 848, and transmit the summary 850 to the client device 804. The summary 850 can include, for example, the statuses of the tasks, performance data associated with the task, or other suitable information of a summary. In some cases, the summarization agent 846 can generate and transmit a summary upon the occurrence of a particular event. For example, the summarization agent 846 can generate and transmit a summary when a predetermined number of tasks have been completed. In some cases, the summarization agent 846 can generate and transmit a summary periodically (e.g., every seven days or thirty days).

In some examples, the generative model used to generate the tasks can be refined based on operations described with respect to FIGS. 2-7. For example, the AI system 802 can generate a plurality of candidate tasks using the generative model. By exploring the plurality of candidate tasks, the AI system 802 can obtain performance data indicating an acceptance level of each candidate task. The AI system 802 can identify a candidate task having a highest acceptance level and generate, based on the candidate task, training data. The AI system 802 can then refine the generative model using the training data. By refining in this manner, the generative model can be encouraged to generate more tasks similar to the one that received positive performance data. On the other hand, if a candidate task receives negative performance data, the model receives a penalty. This feedback signals the model to avoid generating similar tasks in the future and strive for better results.

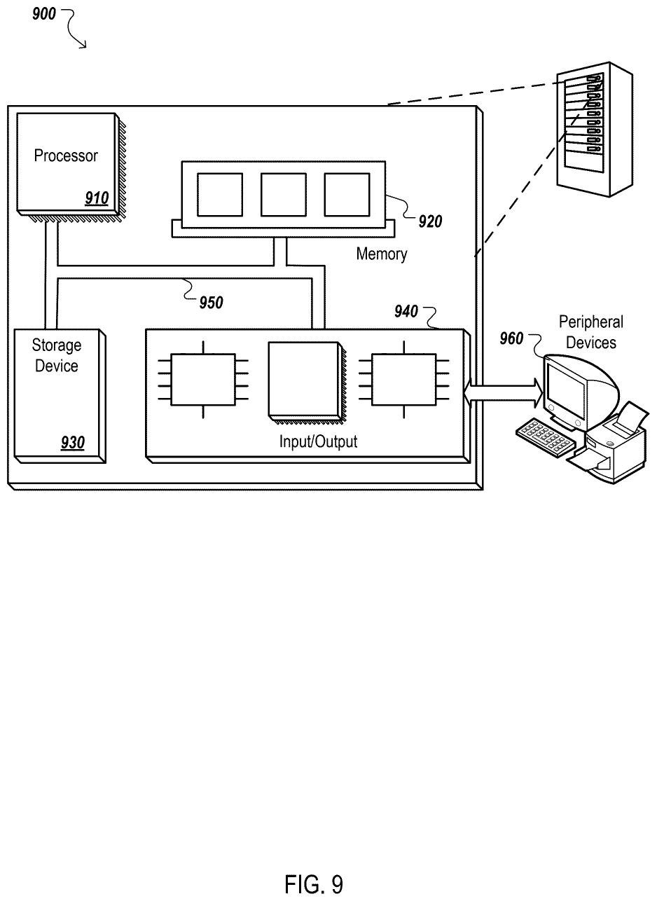

FIG. 9 is a block diagram of an example computer system 900 that can be used to perform described operations, according to an implementation of the present disclosure. The system 900 includes a processor 910, a memory 920, a storage device 930, and an input/output device 940. Each of the components 910, 920, 930, and 940 can be interconnected, for example, using a system bus 950. The processor 910 is capable of processing instructions for execution within the system 900. In one implementation, the processor 910 is a single-threaded processor. In another implementation, the processor 910 is a multi-threaded processor. The processor 910 is capable of processing instructions stored in the memory 920 or on the storage device 930.

The memory 920 stores information within the system 900. In one implementation, the memory 920 is a computer-readable medium. In one implementation, the memory 920 is a volatile memory unit. In another implementation, the memory 920 is a non-volatile memory unit.

The storage device 930 is capable of providing mass storage for the system 900. In one implementation, the storage device 930 is a computer-readable medium. In various different implementations, the storage device 930 can include, for example, a hard disk device, an optical disk device, a storage device that is shared over a network by multiple computing devices (e.g., a cloud storage device), or some other large capacity storage device.

The input/output device 940 provides input/output operations for the system 900. In one implementation, the input/output device 940 can include one or more network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other devices, e.g., keyboard, printer, display, and other peripheral devices 960. Other implementations, however, can also be used, such as mobile computing devices, mobile communication devices, and set-top box television client devices.

Although an example processing system has been described in FIG. 9, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

For situations in which the systems discussed here collect and/or use personal information about users, the users may be provided with an opportunity to enable/disable or control programs or features that may collect and/or use personal information (e.g., information about a user's social network, social actions or activities, a user's preferences, or a user's current location). In addition, certain data may be treated in one or more ways before it is stored or used, so that personally identifiable information associated with the user is removed. For example, a user's identity may be anonymized so that the no personally identifiable information can be determined for the user, or a user's geographic location may be generalized where location information is obtained (such as to a city, ZIP code, or state level), so that a particular location of a user cannot be determined.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

This document refers to a service apparatus. As used herein, a service apparatus is one or more data processing apparatus that perform operations to facilitate the distribution of content over a network. The service apparatus is depicted as a single block in block diagrams. However, while the service apparatus could be a single device or single set of devices, this disclosure contemplates that the service apparatus could also be a group of devices, or even multiple different systems that communicate in order to provide various content to client devices. For example, the service apparatus could encompass one or more of a search system, a video streaming service, an audio streaming service, an email service, a navigation service, an advertising service, a gaming service, or any other service.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory (RAM) or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
obtaining, by an artificial intelligence (AI) system and prior to receiving a query, input data;
generating, by the AI system and based on the input data, one or more candidate digital components using a machine learning model;
obtaining, by the AI system, user preference data limiting usage of at least one candidate digital component of the one or more candidate digital components;
receiving, by the AI system, the query;
identifying, by the AI system, one or more digital component regulations associated with the query;
identifying, by the AI system based on the one or more digital component regulations and the user preference data, at least one particular candidate digital component of the one or more candidate digital components; and
generating, by the AI system and based on the at least one particular candidate digital component of the one or more candidate digital components, an output digital component.

2. The computer-implemented method of claim 1, wherein generating, by the AI system and based on the input data, the one or more candidate digital components using the machine learning model comprises:
generating, by the AI system, a prompt comprising the input data;
inputting, by the AI system, the prompt into the machine learning model; and
generating, by the machine learning model, the one or more candidate digital components.

3. The computer-implemented method of claim 2, wherein generating, by the AI system, the prompt comprising the input data comprises:
obtaining, by the AI system, additional input data comprising data different from the input data, wherein the additional input data limits digital components generated by the machine learning model; and
generating, by the AI system, the prompt comprising the input data and the additional input data.

4. The computer-implemented method of claim 1, wherein the user preference data indicates at least one of a serving time period, a geographical location, or an event for using the at least one candidate digital component of the one or more candidate digital components.

5. The computer-implemented method of claim 1, comprising, before receiving the query:
obtaining, by the AI system, one or more basic regulation review results associated with the one or more candidate digital components, wherein each basic regulation review result indicates whether a corresponding candidate digital component violates a basic digital component regulation.

6. The computer-implemented method of claim 5, wherein obtaining, by the AI system, the one or more basic regulation review results associated with the one or more candidate digital components comprises:
inputting a candidate digital component and one or more basic digital component regulations into an additional machine learning model to determine whether the candidate digital component violates at least one of the one or more basic digital component regulations.

7. The computer-implemented method of claim 5, comprising:
determining, by the AI system, that a basic regulation review result indicates that a candidate digital component violates a basic digital component regulation; and
in response to determining that the basic regulation review result indicates that the candidate digital component violates the basic digital component regulation, removing the candidate digital component from the one or more candidate digital components.

8. The computer-implemented method of claim 1, wherein identifying, by the AI system based on the one or more digital component regulations and the user preference data, the at least one particular candidate digital component of the one or more candidate digital components comprises:
determining whether a candidate digital component complies with the one or more digital component regulations and the user preference data.

9. The computer-implemented method of claim 8, wherein determining whether the candidate digital component complies with the one or more digital component regulations and the user preference data comprises:
inputting the candidate digital component, the one or more digital component regulations, and the user preference data into an additional machine learning model to determine whether the candidate digital component complies with the one or more digital component regulations and the user preference data.

10. The computer-implemented method of claim 1, comprising:
obtaining, by the AI system, performance data indicating an acceptance level of each candidate digital component of the one or more candidate digital components, wherein identifying, by the AI system based on the one or more digital component regulations and the user preference data, the at least one particular candidate digital component of the one or more candidate digital components comprises:
identifying, by the AI system based on the one or more digital component regulations, the user preference data, and the performance data, the at least one particular candidate digital component of the one or more candidate digital components.

11. A computer-implemented method, comprising:
providing, by an artificial intelligence (AI) system, a plurality of levels of automation comprising an automatic mode;
receiving, by the AI system, a first query indicating the automatic mode, the first query comprising a first objective;
generating, by the AI system using a generative model and based on the first query, one or more first tasks for achieving the first objective; and
automatically executing, by the AI system, the one or more first tasks.

12. The computer-implemented method of claim 11, wherein the plurality of levels of automation comprise a semi-automatic mode, and wherein the computer-implemented method comprises:
receiving, by the AI system, a second query indicating the semi-automatic mode, the second query comprising a second objective;
generating, by the AI system using the generative model and based on the second query, one or more second tasks for achieving the second objective;
transmitting, by the AI system to a client device, the one or more second tasks;
receiving, by the AI system from the client device, an approval of the one or more second tasks; and
executing, by the AI system, the one or more second tasks.

13. The computer-implemented method of claim 11, wherein generating, by the AI system using the generative model and based on the first query, the one or more first tasks for achieving the first objective comprises:
generating, by the AI system, a prompt comprising the first query;
inputting, by the AI system, the prompt into the generative model; and
generating, by the generative model, the one or more first tasks.

14. The computer-implemented method of claim 11, comprising:
generating, by the AI system, a prioritized task list indicating a sequence of executing the one or more first tasks,
wherein automatically executing, by the AI system, the one or more first tasks comprises:
automatically executing, by the AI system, the one or more first tasks based on the sequence of executing the one or more first tasks.

15. The computer-implemented method of claim 11, comprising:
identifying, by the AI system, performance data associated with executing the one or more first tasks;
generating, by the AI system, training data based on the performance data; and
refining, by the AI system, the generative model using the training data.

16. The computer-implemented method of claim 15, wherein the performance data comprises at least one of clickthrough rate (CTR), conversion rate (CVR), or cost per day (CPD).

17. The computer-implemented method of claim 11, comprising:
generating, by the AI system, a summary based on execution results associated with the one or more first tasks; and
transmitting, by the AI system, the summary to a client device.

18. A computer-implemented artificial intelligence (AI) system comprising:
one or more processors; and
one or more storage devices storing instructions that, when executed by the one or more processors, cause the one or more processors to perform operations comprising:
obtaining, by an artificial intelligence (AI) system and prior to receiving a query, input data;
generating, by the AI system and based on the input data, one or more candidate digital components using a machine learning model;
obtaining, by the AI system, user preference data limiting usage of at least one candidate digital component of the one or more candidate digital components;
receiving, by the AI system, the query;
identifying, by the AI system, one or more digital component regulations associated with the query;
identifying, by the AI system based on the one or more digital component regulations and the user preference data, at least one particular candidate digital component of the one or more candidate digital components; and
generating, by the AI system and based on the at least one particular candidate digital component of the one or more candidate digital components, an output digital component.

19. The system of claim 18, wherein generating, by the AI system and based on the input data, the one or more candidate digital components using the machine learning model comprises:
generating, by the AI system, a prompt comprising the input data;
inputting, by the AI system, the prompt into the machine learning model; and
generating, by the machine learning model, the one or more candidate digital components.

20. The system of claim 19, wherein generating, by the AI system, the prompt comprising the input data comprises:
obtaining, by the AI system, additional input data comprising data different from the input data, wherein the additional input data limits digital components generated by the machine learning model; and
generating, by the AI system, the prompt comprising the input data and the additional input data.
